(19) United States
(12) Patent Application Publication
(10) Pub. No.: US 2026/0222997 A1
(43) Pub. Date: Jul. 30, 2026

(54) DEVICE FILTER FOR ONBOARDING IN A SYNCHRONIZATION SYSTEM

(71) Applicant: QUALCOMM Incorporated, San Diego, CA (US)

(72) Inventors: Yibo ZHAO, Shanghai (CN); Nicolas GRAUBE, Cambridge (GB); Zaiyong CHEN, Shanghai (CN); Zhaoming YANG, Shanghai (CN); Jie ZHANG, Shanghai (CN); Pulong XIE, Shanghai (CN); Zhuxian GU, Suzhou (CN); Yaqiong WANG, Shanghai (CN); Jiahui PAN, Shanghai (CN); Mozhou LIU, Shanghai (CN)

(21) Appl. No.: 19/146,887

(22) PCT Filed: Mar. 1, 2023
(86) PCT No.: PCT/CN2023/078943

§ 371 Date: Jul. 9, 2025

(51) Int. Cl. H04W 52/02; H04W 12/06; H04W 60/04

(52) U.S. Cl. CPC H04W 52/0235; H04W 12/06; H04W 60/04

(57) ABSTRACT

Systems and techniques are described herein for device onboarding in a synchronization system. For example, a network entity can transmit a wake-up packet to wireless communication devices. The wake-up packet can include a device filter value indicative of a first subset of wireless communication devices of the wireless communication devices. The network entity can receive, from the first subset of wireless communication devices, one or more advertising packets corresponding to the wake-up packet. The network entity can determine a receive rate associated with the one or more advertising packets. Based on the receive rate being less than a threshold, the network entity can transmit an updated wake-up packet to the plurality of wireless communication devices. The updated wake-up packet includes an updated device filter value indicative of the first subset and additional wireless communication device(s) of the plurality of wireless communication devices.

### FIELD OF THE DISCLOSURE

The present disclosure generally relates to wireless communications. For example, aspects of the present disclosure relate to device onboarding in a synchronization system including one or more network devices (e.g., access points (APs)) and one or more wireless communication devices (e.g., peripheral devices, such as electronic shelf labels (ESLs)).

### BACKGROUND OF THE DISCLOSURE

Short range wireless communication enables wireless communication over relatively short distances (e.g., within thirty meters). For example, BLUETOOTH® is a wireless technology standard for exchanging data over short distances using short-wavelength ultra-high frequency (UHF) radio waves from 2.4 gigahertz (GHz) to 2.485 GHz.

BLUETOOTH® Low Energy (BLE) is a form of BLUETOOTH® communication that allows for communication with devices running on low power. Such devices may include beacons, which are wireless communication devices that may use low-energy communication technology for positioning, proximity marketing, or other purposes. In some cases, such devices may serve as nodes (e.g., relay nodes) of a wireless mesh network that communicates and/or relays information to a managing platform or hub associated with the wireless mesh network.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems, methods, apparatuses, and computer-readable media for performing wireless communication. According to at least one illustrative example, a network entity for wireless communications is provided. The network entity includes at least one memory and at least one processor coupled to the at least one memory and configured to: transmit a wake-up packet to a plurality of wireless communication devices, wherein the wake-up packet includes a device filter value indicative of a first subset of wireless communication devices of the plurality of wireless communication devices; receive, from the first subset of wireless communication devices, one or more advertising packets corresponding to the wake-up packet; determine a receive rate associated with the one or more advertising packets; and based on the receive rate being less than a threshold, transmit an updated wake-up packet to the plurality of wireless communication devices, wherein the updated wake-up packet includes an updated device filter value indicative of the first subset and one or more additional wireless communication devices of the plurality of wireless communication devices.

In another illustrative example, a method for wireless communications performed by a network entity is provided. The method includes: transmitting a wake-up packet to a plurality of wireless communication devices, wherein the wake-up packet includes a device filter value indicative of a first subset of wireless communication devices of the plurality of wireless communication devices; receiving, from the first subset of wireless communication devices, one or more advertising packets corresponding to the wake-up packet; determining a receive rate associated with the one or more advertising packets; and based on the receive rate being less than a threshold, transmitting an updated wake-up packet to the plurality of wireless communication devices, wherein the updated wake-up packet includes an updated device filter value indicative of the first subset and one or more additional wireless communication devices of the plurality of wireless communication devices.

In another illustrative example, a non-transitory computer-readable medium is provided that has stored thereon instructions that, when executed by at least one processor, cause the at least one processor to: transmit a wake-up packet to a plurality of wireless communication devices, wherein the wake-up packet includes a device filter value indicative of a first subset of wireless communication devices of the plurality of wireless communication devices; receive, from the first subset of wireless communication devices, one or more advertising packets corresponding to the wake-up packet; determine a receive rate associated with the one or more advertising packets; and based on the receive rate being less than a threshold, transmit an updated wake-up packet to the plurality of wireless communication devices, wherein the updated wake-up packet includes an updated device filter value indicative of the first subset and one or more additional wireless communication devices of the plurality of wireless communication devices.

In another illustrative example, a network entity for wireless communications is provided. The network entity includes: means for transmitting a wake-up packet to a plurality of wireless communication devices, wherein the wake-up packet includes a device filter value indicative of a first subset of wireless communication devices of the plurality of wireless communication devices; means for receiving, from the first subset of wireless communication devices, one or more advertising packets corresponding to the wake-up packet; determining a receive rate associated with the one or more advertising packets; and means for, based on the receive rate being less than a threshold, transmitting an updated wake-up packet to the plurality of wireless communication devices, wherein the updated wake-up packet includes an updated device filter value indicative of the first subset and one or more additional wireless communication devices of the plurality of wireless communication devices.

Aspects generally include a method, apparatus, system, computer program product, non-transitory computer-readable medium, user device, user equipment, wireless communication device, and/or processing system as substantially described with reference to and as illustrated by the drawings and specification.

Some aspects include a device having a processor configured to perform one or more operations of any of the methods summarized above. Further aspects include processing devices for use in a device configured with processor-executable instructions to perform operations of any of the methods summarized above. Further aspects include a non-transitory processor-readable storage medium having stored thereon processor-executable instructions configured to cause a processor of a device to perform operations of any of the methods summarized above. Further aspects include a device having means for performing functions of any of the methods summarized above.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

### BRIEF DESCRIPTION OF THE DRAWINGS

The accompanying drawings are presented to aid in the description of various aspects of the disclosure and are provided solely for illustration of the aspects and not limitation thereof. So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example environment in which systems and/or methods described herein may be implemented, in accordance with some examples;

FIG. 2 is a diagram illustrating example components of a device, in accordance with some examples;

FIG. 3 is a signaling diagram illustrating example communication transmissions, in accordance with some examples;

FIG. 4 is a signaling diagram illustrating an example of communication transmissions between a network device and two groups of wireless communication devices, in accordance with some examples;

FIG. 5 is a diagram illustrating an example of onboarding performed using a management entity (ME) in a synchronization system, in accordance with some examples;

FIG. 6A is a diagram illustrating a first example of a receive rate associated with connectable advertising packets (CAPs) received at a network entity, in accordance with some examples;

FIG. 6B is a diagram illustrating a second example of a receive rate associated with CAPs received at a network entity, in accordance with some examples;

FIG. 7 is a flow diagram illustrating an example of onboarding that can be performed based on a device filter of a wake-up packet (WUP) updated by an access point (AP) in a synchronization system, in accordance with some examples;

FIG. 8 is a flow chart illustrating an example of a process for wireless communications at a network device, in accordance with some examples; and

FIG. 9 is a block diagram illustrating an example of a computing system, which may be employed by the disclosed systems and techniques, in accordance with some examples.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the scope of the application as set forth in the appended claims.

A system may include one or more wireless communication devices that are controlled by a network entity. For example, an electronic shelf label (ESL) system may include one or more wireless communication devices (e.g., ESLs) that are controlled by a network entity, such as a management entity (ME), via at least one network device, such as an access point (AP). In one or more examples, to facilitate control by the management entity, each ESL may have a wireless connection (e.g., a BLUETOOTH® Low Energy (BLE) connection or other connection) to an access point (AP) that is communicatively connected to the management entity (e.g., via the Internet, such as wirelessly, via an Ethernet connection, etc.). In some cases, commands from the management entity may be wirelessly transmitted to the ESLs by the access point. Responses or information from the ESLs may also be received by the access point and provided by the access point to the management entity. While examples are described herein using ESLs as illustrative examples of wireless communication devices, a management entity as an example of a network entity, and access points as examples of network devices, the systems and techniques described herein are applicable to any type of system or network.

In some examples, ESL systems can be deployed to support and manage ESL devices in stores (e.g., supermarkets) and other retail spaces. In some examples, ESL systems may be deployed to support and manage ESL devices in warehouses (e.g., distribution centers) and other industrial spaces. For instance, in a store, ESLs may be provided as electronic labels that are affixed to store shelves to identify the items and the price of the items located on the store shelf above the label. ESLs may be each implemented with a display (e.g., a liquid crystal display (LCD), an electronic paper (e-paper) display, etc.). The ESL may digitally display the name of the item, a product identification number for the item, such as a stock keeping unit (SKU) number, and a price for the item. The ESL may additionally display a barcode for the item, a quick response (QR) code for the item, and/or an image (e.g., a picture) of the item. In some examples, each ESL may include a display and a radio or wireless transceiver for communicating with one or more APs and/or MEs included in the ESL system. For example, during operation of the ESL system, the information displayed on the ESLs may be updated periodically by using periodic advertisements (PAs), as will be described in greater depth below.

As noted previously, in some examples, ESL systems can additionally, or alternatively, be used to support and manage ESL devices in warehouses (e.g., distributions) and other industrial spaces. For example, in a warehouse or distribution center, ESL devices can be provided as trackers that are attached to pallets or various other shipping containers that are moved throughout the warehouse and/or transported in a supply chain. In some examples, a tracker can be provided as a printed active (e.g., battery-powered) Bluetooth® Low Energy (BLE) label. A BLE tracker can be implemented based on (e.g., can be compliant with) the ESL protocol. For example, a BLE tracker can be attached to a pallet of merchandise and used to track the pallet of merchandise as it moves from a global distribution center (GDC) to a retail store environment.

In ESL systems, periodic advertisements (PAs) can be utilized to provide regular and predictable payload transmissions from a network device (e.g., such as an AP) to one or more wireless communication devices (e.g., such as ESLs). For example, PAs can be used to issue information from a network device to multiple wireless communication devices, which may be within one or more groups of wireless communication devices. PAs are generally unidirectional (e.g., unidirectional transmissions) such that PAs are transmitted only one-way from a network device (e.g., AP) to one or more wireless communication devices (e.g., ESLs). In some examples, the information displayed on the ESLs may be updated periodically by using periodic advertisements (PAS), as noted previously above.

Periodic Advertisement with Response (PAwR) can be used for ESL systems to provide bidirectionality (e.g., bidirectional transmissions between a central device and one or more peripheral devices). Wireless communication devices (e.g., peripheral devices, such as ESLs) synchronized within a group of wireless communication devices can be addressed by a network device (e.g., AP) on a synchronized channel (e.g., a radio frequency (RF) channel between the network device and the wireless communication devices) whenever the network device chooses to send (e.g., transmit) a request to the wireless communication devices. In some cases, as used herein, a synchronized channel refers to a channel on which transmissions are synchronized (in time). For example, the channel can include a frequency on which one or more communications are transmitted. A hopping frequency sequence can be associated with the channel, where the hopping frequency sequence progresses at a fixed and/or pre-determined interval. A central device (e.g., AP, ME, etc.) and one or more peripheral devices (e.g., ESLs) can concurrently track the hopping frequency sequence at the predefined frequency hopping pattern (e.g., such that the central device knows when to transmit the request and the peripheral devices know when to listen for and/or receive the request).

In some cases, a request transmitted by a central device to peripheral devices in a particular group may be a PA containing a synchronization message transmitted by the central device on the synchronized channel to the peripheral devices of the particular group. For example, wireless communication devices (e.g., ESLs) within the particular group can wake up (e.g., from a powered off or shut-down state) at the same PA transmission with respect to a particular PAwR train for that group. A PA transmission can include a periodic set of transmissions, which may be collectively referred to as a PA train, or a PAwR train when applied to PAwR. Each transmission of a PA train (or PAwR train) occurs at a precise point in time, with fixed intervals between the transmissions. A communication channel (e.g., one communication channel out of thirty-seven available communication channels) is selected for each of the transmissions, where the communication channel follows a hopping frequency sequence.

In some cases, a peripheral device (e.g., an ESL device) can wake up to perform an onboarding process with a central device (e.g., an AP, ME, etc.). For example, an ESL system can include an ME and one or more APs, as noted above. A plurality of ESLs can be added to the ESL system (e.g., registered with the ESL system) based on an onboarding process performed between each ESL and an AP. An ESL that has not yet been onboarded, or is otherwise awaiting onboarding, can enter a dormant or sleep state while awaiting an onboarding indication or other onboarding trigger. For example, ESLs that have not been onboarded with an ESL system (e.g., have not been onboarded with an AP and/or ME of an ESL system) can remain in a dormant or sleep state until a wake-up packet (WUP) is received. For example, a timer can be used to periodically cause an ESL to wake from the dormant state and check to see if a WUP is received. The ESL may return to the dormant state if a WUP is not received within a pre-determined duration following the periodic wakeup.

A WUP can indicate to one or more ESLs (e.g., one or more ESLs receiving the WUP) that the ESL is within communication range of an active ESL system and that the ESL should attempt to perform an onboarding process with the ESL system. For instance, an AP can be used to transmit (e.g., broadcast) a WUP that causes one or more ESLs to wake up and attempt to perform onboarding with the AP. WUPs can be periodically transmitted by one or more APs included in an ESL system. In some cases, an ME of the ESL system can cause the one or more APs to periodically transmit the WUPs. In addition to causing an ESL to wake up and attempt onboarding with an AP of the ESL system, a WUP may additionally contain configuration information that can be used by the ESL to perform onboarding with the AP. In some cases, the WUP can be generated by an ME associated with the AP, where the AP receives a WUP from the ME and broadcasts the WUP to a plurality of ESLs. In some examples, onboarding may be performed when one or more ESLs are initially added to an ESL system and/or may be performed when one or more existing ESLs are included in an ESL system that is reset or reconfigured.

In some cases, a WUP can be generated by an ME of an ESL system and used to wake up ESLs to send Connectable Advertising Packets (CAPs). For example, an ESL receiving a WUP may transition from a dormant or sleep state to an unassociated state, where the unassociated state corresponds to an onboarding process performed by the ESL. In the unassociated state, the ESL can attempt onboarding based on generating and transmitting (e.g., broadcasting) a CAP corresponding to the ESL. For instance, a CAP transmitted by a particular ESL can be indicative of information of the ESL that allows an AP receiving the CAP to initiate a connection and establish synchronization with the ESL (e.g., an ESL that is onboarded with an AP is synchronized with the AP). For example, a CAP transmitted by a particular ESL can be indicative of an identity of the ESL and/or a state of the ESL, among various other information. The CAPs can be received by one or more APs of the ESL system and provided to an ME of the ESL system. The ME can use the CAPs to determine a particular AP of the ESL system to synchronize the ESL with. The ME can inform the selected AP of the determination and can cause the selected AP to initiate a connection to the ESL.

APs and/or other network entities in an ESL system may have a limited quantity of communication links that can be used to perform onboarding (e.g., establish synchronization) with ESLs. For example, an AP may support a maximum of three simultaneous or concurrent links with ESLs. In many examples, an ESL system may be associated with a plurality of peripheral devices (e.g., ESLs) that are to be onboarded at the same time. For instance, when an ESL system is initially installed and configured at a given location (e.g., such as a supermarket or other retail environment), thousands of ESLs may need to be onboarded at approximately the same time. In some cases, the onboarding of a plurality of ESLs may also be referred to as “massive onboarding.”

Massive onboarding of ESLs can be limited by the quantity of simultaneous communication links supported by or otherwise associated with the APs of the ESL system. When the total quantity of ESLs to be onboarded is greater than the total quantity of available links of the APs of an ESL system, respective CAPs transmitted by the various ESLs (e.g., in response to receiving a WUP broadcast by an AP) may interfere with one another or otherwise not be received at an AP. For example, if all of the ESLs receiving the WUP attempt to onboard at the same time, many (or all) of the ESLs may be unable to successfully onboard with an AP.

In some cases, an ME of an ESL system can generate a WUP to include a device filter field indicative of a range of ESLs (e.g., a range of ESL addresses or identifiers) for which the WUP is valid. As used herein, a WUP that “addresses” an ESL (or other wireless communication device) is a WUP having a device filter value that is determined to be valid for the particular wireless ESL. For example, each respective ESL of a plurality of ESLs receiving the WUP can use the device filter field value to determine whether the received WUP is valid for the respective ESL. For instance, the device filter field can have a value that is chosen (e.g., by the ME) such that the sum of the octets of a Bluetooth Device Address (BD_ADDR) of a first subset of ESLs is less than the device filter value and the sum of the octets of the BD_ADDR of a second subset of ESLs is greater than the device filter value. In one illustrative example, a WUP can be considered valid by an ESL if the device filter value of the WUP is less than or equal to the sum of the octets of the BD_ADDR of the ESL (e.g., in the example above, the WUP would be valid for the second subset of ESLs).

Based on the value of the device filter field utilized in each WUP of a series of WUPs generated by the ME of an ESL system, the ME can control the wake-up and onboarding of a plurality of ESLs during a massive onboarding process performed by or for the ESL system. For example, the ME can adjust the device filter field value such that the quantity of ESLs eligible for onboarding (e.g., the quantity of ESLs for which the WUP is valid, based on the device filter field value being less than or equal to the sum of the octets of the BD_ADDR of the ESL) is approximately the same as the quantity of available links supported by the APs of the ESL system. By adjusting the device filter field value to perform a controlled or gradual onboarding of ESLs during a massive onboarding process, interference between the CAPs transmitted by various ESLs attempting to onboard at the same time can be reduced and/or the total power expended by ESLs attempting to onboard can be reduced.

In some cases, ESLs that are to be onboarded can be added to a whitelist (e.g., a permitted list) in the APs of the ESL system. The whitelist can be maintained in the AP firmware (FW) of the APs of the ESL system. For instance, the whitelist can be controlled by the ME associated with the APs, based on the ME having awareness of the ESLs that are to be soon onboarded (e.g., based on the ME determining the device filter field value of the WUP that controls which ESL BD_ADDRs will view the WUP as valid and attempt onboarding).

During onboarding, the ME can receive onboarding results and generate updated device filter field values based on the onboarding results. For example, the ME can receive onboarding results from the APs associated with the ME. The onboarding results are indicative of particular ESLs that have been successfully onboarded and/or particular ESLs that were not successfully onboarded or are not yet onboarded. For instance, as ESLs are successfully onboarded, the ME can lower the value of the device filter field and transmit one or more WUPs using the updated device filter field value (e.g., thereby waking more ESLs for onboarding).

The onboarding results information received by the ME from the associated APs is often indicative of only the onboarding result for each ESL included in the range of ESL BD_ADDRs to which the WUP was addressed (e.g., the range of ESLs for which the WUP device filter field was valid). For example, the onboarding result information may include a confirmation indicating that an ESL was successfully onboarded and/or the absence of a confirmation, indicating that an ESL was not successfully onboarded. Based on onboarding results being determined or measured at the APs of the ESL system and being reported back to the ME associated with the APs, a communication overhead is associated with the ME determining the onboarding results. Additionally, information such as connection state and/or CAP receiving density at various APs associated with the ME may be inaccurate, difficult to determine, or otherwise unavailable to the ME. Based on the incomplete onboarding result information and/or the outdated onboarding result information available at the ME, the ME may update the device filter field value of subsequent WUPs to be overinclusive or underinclusive of additional ESLs to wake for onboarding. The ME may additionally update the device filter field value using a periodicity or interval that is either too short or too long relative to an optimal device filter field value update periodicity.

There is a need for systems and techniques that can be used to more efficiently perform onboarding of ESLs to an ESL system. There is an additional need for systems and techniques that can be used to more efficiently perform massive onboarding of ESLs to an ESL system. For instance, there is a need for massive onboarding that can be performed using WUPs having device filter field values that are updated based on accurate and/or real-time onboarding result information at the various APs associated with an ME of an ESL system.

Systems, apparatuses, processes (also referred to as methods), and computer-readable media (collectively referred to as “systems and techniques”) are described herein that can be used to more efficiently perform onboarding of ESLs and/or other peripheral devices. For example, the systems and techniques can utilize a wake-up packet (WUP) with an initialized device filter value determined by a management entity (ME) and updated WUPs with respective updated device filter values determined by an access point (AP) associated with the ME. In some cases, the initial WUP generated by the ME can be transmitted to one or more APs. The initial WUP can include a device filter authorization field indicating that the AP has been authorized to automatically adjust the device filter value. Based on receiving (e.g., from the ME) a WUP including the device filter authorization field, one or more APs associated with the ME can subsequently determine device filter values locally. The locally determined device filter values can be used to generate and transmit updated WUPs (e.g., WUPs including the locally determined device filter value) to a plurality of ESLs or other peripheral devices for performing an onboarding process with one of the APs.

In some cases, an AP can determine an updated device filter value based on receive rate information corresponding to the AP. For example, the AP can determine a receive rate associated with the AP receiving advertising packets transmitted by one or more ESLs. In some cases, the advertising packets can be Connectable Advertising Packets (CAPs) transmitted by respective ESLs in response to receiving a valid WUP from the AP. In some examples, the AP can determine a CAP receive rate indicative of a quantity of CAPs received by the AP during a time period. For instance, the time period can correspond to a subframe, a frame, etc.

In some cases, the AP can determine the CAP receive rate based on a total scan time of the AP during a time period. For example, an AP may utilize a first time allocation per subframe to scan for packets, a second time allocation per subframe for connections, a third time allocation per subframe for Periodic Advertisements (PAS), etc. In some cases, the AP may be configured to receive packets (e.g., such as CAPs) transmitted by ESLs during only a portion of the time allocation(s) per subframe. For instance, an AP may receive CAPs during a total scan time allocation for a subframe, but may miss or otherwise not receive CAPs during the connection and/or PA time allocations of the subframe. In one illustrative example, the AP can determine its corresponding CAP receive rate as the total quantity of CAPs received during a time period (e.g., such as a subframe) divided by the total scan time of the AP during the same time period (e.g., the APs scan time for the subframe in which the CAPs were received).

In some aspects, the systems and techniques described herein can perform massive onboarding of a plurality of ESL devices using one or more updated WUPs that are generated and transmitted by APs of an ESL system. Each updated WUP can be generated by a respective one of the APs, and may include an updated device filter value that is determined based on onboarding information corresponding to the respective AP. For instance, the onboarding information can be onboarding results for the respective AP. The onboarding results are indicative of ESLs that are successfully onboarded (e.g., an onboarding confirmation) and/or are indicative of ESLs that have not been successful onboarded (e.g., a negative confirmation, an absence of an onboarding confirmation, etc.). In some cases, the CAP receive rate (e.g., also referred to herein as the “CAP rate” or “receive rate”) corresponding to the respective AP can additionally be utilized to perform the massive onboarding of the plurality of ESLs. In some examples, the CAP receive rate for the AP can be included in the onboarding information and/or onboarding results corresponding to the AP. In some cases, the CAP receive rate for the AP can be separate from the onboarding information and/or onboarding results corresponding to the AP.

Additional aspects of the present disclosure are described with reference to the figures.

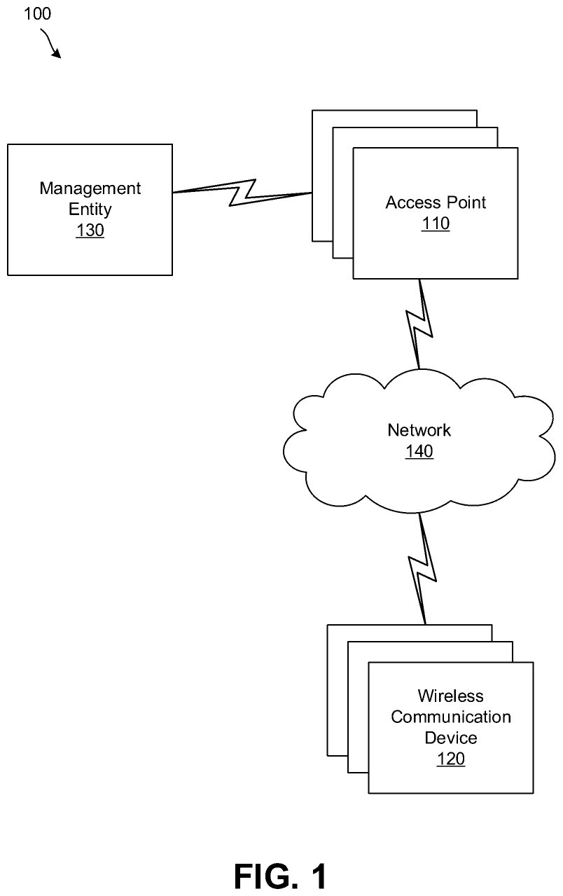

FIG. 1 is a diagram of an example environment 100 in which systems and/or methods described herein may be implemented. As shown in FIG. 1, the environment 100 may include at least one access point (AP) 110, at least one wireless communication device 120, a management entity (ME) 130, and a network 140. Devices of the environment 100 may interconnect via wired connections, wireless connections, or a combination of wired and wireless connections.

The access point 110 may include one or more devices capable receiving, generating, storing, processing, providing, and/or routing information associated with access point synchronization and/or handover, as described elsewhere herein. The access point 110 may include a communication device and/or a computing device. The access point 110 may be configured to transmit beacons (e.g., BLE beacons), as well as to scan and locate other devices (e.g., other devices communicating using BLE protocols).

The wireless communication device 120 may include one or more devices capable of receiving, generating, storing, processing, and/or providing information associated with access point synchronization and/or handover, as described elsewhere herein. The wireless communication device 120 may include a communication device and/or a computing device. In some aspects, the wireless communication device 120 may be, may include, or may be included in an electronic shelf label (ESL).

The management entity 130 includes one or more devices capable of receiving, generating, storing, processing, providing, and/or routing information associated with access point synchronization and/or handover, as described elsewhere herein. The management entity 130 may include a communication device and/or a computing device. For example, the management entity 130 may include a server, such as an application server, a client server, a web server, a database server, a host server, a proxy server, a virtual server (e.g., executing on computing hardware), or a server in a cloud computing system. In some aspects, the management entity 130 includes computing hardware used in a cloud computing environment. The management entity 130 may provide control of a system (e.g., an ESL system) that includes the access point(s) 110, the wireless communication device(s) 120, and/or the device(s) 130. The access point(s) 110 may be communicatively connected to the management entity 130 via a network (not shown), such as the Internet.

The network 140 may include one or more wireless networks. For example, the network 140 may include a personal area network (e.g., a Bluetooth network). The network 140 enables communication among the devices of environment 100.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) of environment 100 may perform one or more functions described as being performed by another set of devices of environment 100.

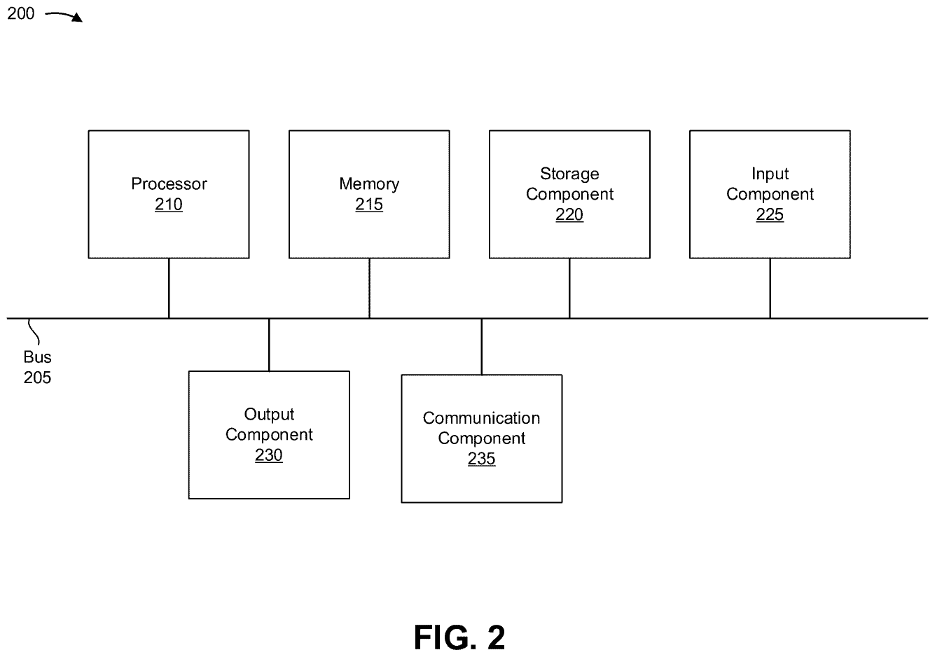

FIG. 2 is a diagram illustrating example components of a device 200, in accordance with the present disclosure. Device 200 may correspond to access point 110, wireless communication device 120, and/or management entity 130. In some aspects, access point 110, wireless communication device 120, and/or management entity 130 may include one or more devices 200 and/or one or more components of device 200. As shown in FIG. 2, device 200 may include a bus 205, a processor 210, a memory 215, a storage component 220, an input component 225, an output component 230, and/or a communication component 235.

Bus 205 may include a component that permits communication among the components of device 200. Processor 210 may be implemented in hardware, firmware, or a combination of hardware and software. Processor 210 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some aspects, processor 210 may include one or more processors capable of being programmed to perform a function. Memory 215 may include a random access memory (RAM), a read only memory (ROM), and/or another type of dynamic or static storage device (e.g., a flash memory, a magnetic memory, and/or an optical memory) that stores information and/or instructions for use by processor 210.

Storage component 220 can store information and/or software related to the operation and use of device 200. For example, storage component 220 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

Input component 225 may include a component that permits device 200 to receive information, such as via user input (e.g., a touch screen display, a keyboard, a keypad, a mouse, a button, a switch, and/or a microphone). Additionally, or alternatively, input component 225 may include a component for determining a position or a location of device 200 (e.g., a global positioning system (GPS) component or a global navigation satellite system (GNSS) component) and/or a sensor for sensing information (e.g., an accelerometer, a gyroscope, an actuator, or another type of position or environment sensor). Output component 230 can include a component that provides output information from device 200 (e.g., a display, a speaker, a haptic feedback component, and/or an audio or visual indicator).

Communication component 235 may include one or more transceiver-like components (e.g., a transceiver and/or a separate receiver and transmitter) that enables device 200 to communicate with other devices, such as via a wired connection, a wireless connection, or a combination of wired and wireless connections. Communication component 235 may permit device 200 to receive information from another device and/or provide information to another device. For example, communication component 235 may include an Ethernet interface, an optical interface, a coaxial interface, an infrared interface, a radio frequency interface, a universal serial bus (USB) interface, a wireless local area interface (e.g., a Wi-Fi interface or a BLE interface), and/or a cellular network interface.

Communication component 235 may include one or more antennas for receiving wireless radio frequency (RF) signals transmitted from one or more other devices, cloud networks, and/or the like. The antenna may be a single antenna or an antenna array (e.g., antenna phased array) that can facilitate simultaneous transmit and receive functionality. The antenna may be an omnidirectional antenna such that signals can be received from and transmitted in all directions. The wireless signals may be transmitted via a wireless network. The wireless network may be any wireless network, such as a cellular or telecommunications network (e.g., 3G, 4G, 5G, etc.), wireless local area network (e.g., a WiFi network), a Bluetooth™ network, and/or other network.

The one or more transceiver-like components (e.g., a wireless transceiver) of the communication component 235 may include an RF front end including one or more components, such as an amplifier, a mixer (also referred to as a signal multiplier) for signal down conversion, a frequency synthesizer (also referred to as an oscillator) that provides signals to the mixer, a baseband filter, an analog-to-digital converter (ADC), one or more power amplifiers, among other components. The RF front-end can generally handle selection and conversion of the wireless signals into a baseband or intermediate frequency and can convert the RF signals to the digital domain.

In some cases, a CODEC may be implemented (e.g., by the processor 210) to encode and/or decode data transmitted and/or received using the one or more wireless transceivers. In some cases, encryption-decryption may be implemented (e.g., by the processor 210) to encrypt and/or decrypt data (e.g., according to the Advanced Encryption Standard (AES) and/or Data Encryption Standard (DES) standard) transmitted and/or received by the one or more wireless transceivers.

In some aspects, device 200 may represent an ESL. The ESL may include a battery in addition to the aforementioned components. In some aspects, the output component 230 of the ESL may be an electronic paper (e-paper) display or a liquid crystal display (LCD).

Device 200 may perform one or more processes described herein. Device 200 may perform these processes based on processor 210 executing software instructions stored by a non-transitory computer-readable medium, such as memory 215 and/or storage component 220. A computer-readable medium is defined herein as a non-transitory memory device. A memory device includes memory space within a single physical storage device or memory space spread across multiple physical storage devices.

Software instructions may be read into memory 215 and/or storage component 220 from another computer-readable medium or from another device via communication component 235. When executed, software instructions stored in memory 215 and/or storage component 220 may cause processor 210 to perform one or more processes described herein. Additionally, or alternatively, hardwired circuitry may be used in place of or in combination with software instructions to perform one or more processes described herein. Thus, aspects described herein are not limited to any specific combination of hardware circuitry and software.

The number and arrangement of components shown in FIG. 2 are provided as an example. In practice, device 200 may include additional components, fewer components, different components, or differently arranged components than those shown in FIG. 2. Additionally, or alternatively, a set of components (e.g., one or more components) of device 200 may perform one or more functions described as being performed by another set of components of device 200.

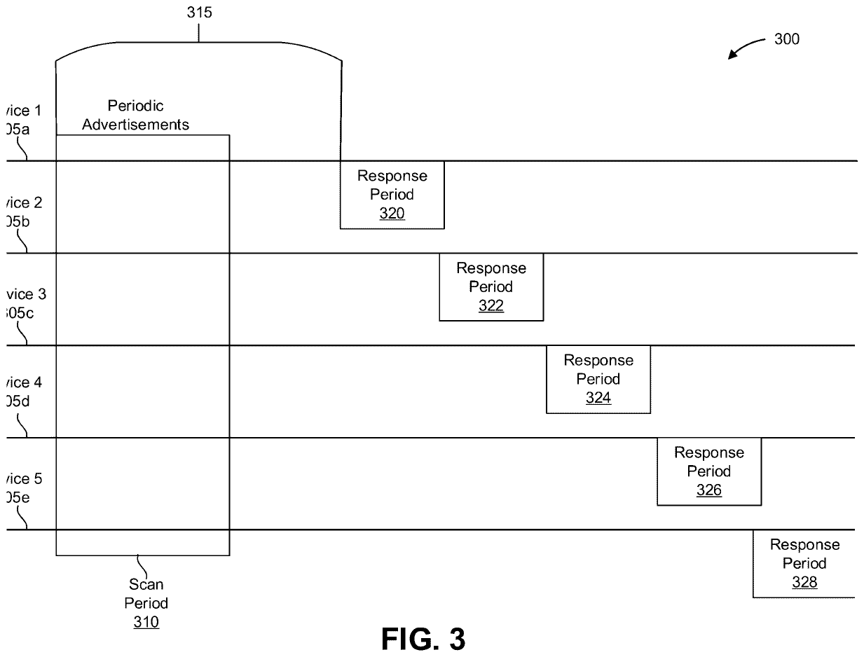

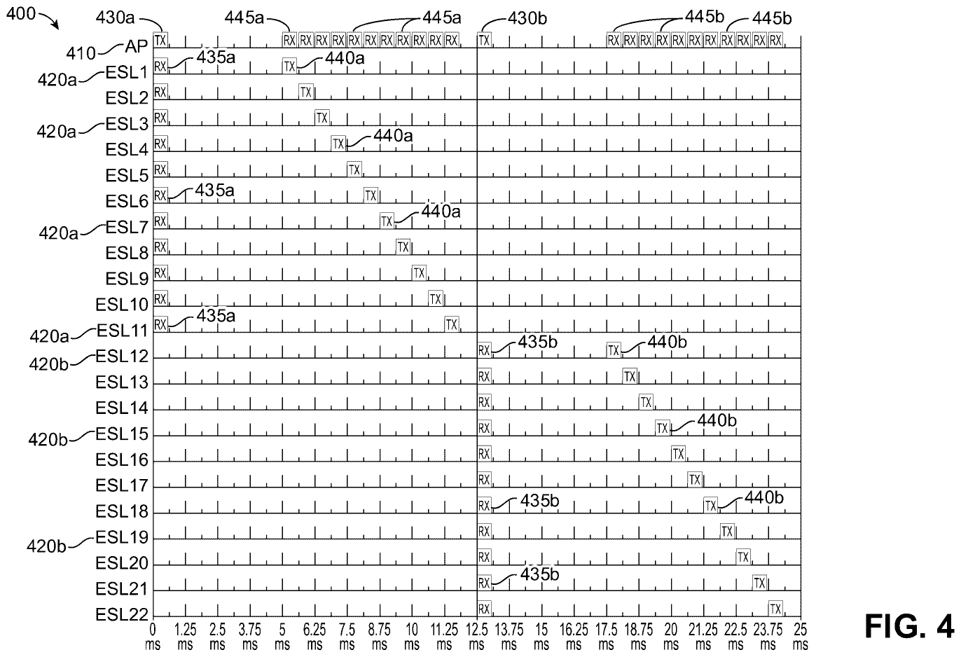

FIGS. 3 and 4 show signaling diagrams illustrating examples of PAwR in an ESL system. For example, the signaling diagram of FIG. 3 illustrates an example PAwR for a group of wireless network devices (e.g., device 1 305a, device 2 305b, device 3 305c, device 4 305d, and device 5 305e), and the signaling diagram of FIG. 4 illustrates an example PAwR for two groups of wireless network devices 420a, 420b (e.g., a first group including ESL1 to ESL 11, and a second group including ESL 12 to ESL 22). Specifically, FIG. 3 is a signal timing diagram illustrating a portion of a communication between an access point (e.g., access point 110) and wireless communication devices 120 (e.g., ESLs). With reference to FIG. 1, the signal sequence illustrated in FIG. 3 may be implemented by at least one of the communication connections, access points 110, and/or wireless communication devices 120 of FIG. 1.

The devices (e.g., device 1 305a, device 2 305b, device 3 305c, device 4 305d, and device 5 305e) of FIG. 3 may be selected from wireless communication devices 120 of FIG. 1 and may each receive a periodic advertisement (PA) in a scan period 310. The scan period 310 may occur in regularly scheduled intervals and may be repeated periodically such that the devices (e.g., device 1 305a, device 2 305b, device 3 305c, device 4 305d, and device 5 305e) can awaken to scan for messages during this repeated scan period 310. An access point (e.g., access point 110 of FIG. 1) may provide periodic advertisements (PAS) via broadcast or multi-cast to the devices (e.g., device 1 305a, device 2 305b, device 3 305c, device 4 305d, and device 5 305e) in the scan period 310. For an access point (e.g., access point 110 of FIG. 1), the scan period 310 can be its primary transmission period. In some cases, the scan period 310 may not be a fixed time because the access point (e.g., access point 110 of FIG. 1) may send different lengths of data from the start of the scan period 310.

The transmission may include multiple advertisements in a train. One or more portions of the advertisements may be directed to one or more of the devices (e.g., device 1 305a, device 2 305b, device 3 305c, device 4 305d, and device 5 305e). The devices (e.g., device 1 305a, device 2 305b, device 3 305c, device 4 305d, and device 5 305e) may decode or filter the messages intended for each specific device and transmitted during the period when all devices are receiving. In this way, the devices (e.g., device 1 305a, device 2 305b, device 3 305c, device 4 305d, and device 5 305e) may be reprogrammed, updated, and/or sent requests from an access point (e.g., access point 110 of FIG. 1) or relayed from another device (e.g., management entity 130 of FIG. 1) through the access point (e.g., access point 110 of FIG. 1). The periodic advertisement (PA) from the access point (e.g., access point 110 of FIG. 1) may set a response period for one or more of the devices (e.g., device 1 305a, device 2 305b, device 3 305c, device 4 305d, and device 5 305e).

As illustrated, the devices (e.g., device 1 305a, device 2 305b, device 3 305c, device 4 305d, and device 5 305e) are each assigned a response period 320, 322, 324, 326, 328 in the time after the scan period 310. In some cases, the assignment of the response period to a particular device may not be permanent. In some aspects, the assignment may be inferred from a payload of a synchronization message. The first response period 320 may begin following an idle time 315 after the scan period 310, with the idle period being long enough to provide the transmitter device an opportunity to do other Bluetooth related activities. The assigned response periods may also be limited to or designate a particular frequency of the channels on which to respond. For example, in FIG. 3, device 1 305a is assigned response period 320, device 2 305b is assigned response period 322, device 3 305c is assigned response period 324, device 4 305d is assigned response period 326, and device 5 305e is assigned response period 328. The access point (e.g., access point 110 of FIG. 1) may store attributes of the devices (e.g., device 1 305a, device 2 305b, device 3 305c, device 4 305d, and device 5 305e), including whether a device is able to transmit or respond. The PA signaling followed by responses can be referred to as periodic advertisement with multiple responses (PAwMR).

For example, device 3 305c (e.g., wireless communication device 120 of FIG. 1) may be an ESL and may receive a price update in a PA from the access point (e.g., access point 110 of FIG. 1) in scan period 310. The PA received at device 3 305c may include a designated start time for the response period 324 or may include a schedule of response start times for devices including device 3 305c. The response by device 3 305c to the access point (e.g., access point 110 of FIG. 1) may include an acknowledgement, a status code, and/or other information such as battery life, received signal strength, and/or an error notification. The response by device 3 305c may include information to be relayed to another device by the access point (e.g., access point 110 of FIG. 1). The response may include a packet with a header and may conform to any of the Bluetooth protocols. A response may be transmitted in a data channel of the Bluetooth protocol to the access point (e.g., access point 110 of FIG. 1). Both the PA and the responses from all of the devices (e.g., device 1 305a, device 2 305b, device 3 305c, device 4 305d, and device 5 305e) may use channels of the Bluetooth protocol.

A device (e.g., device 5 305e) that has been assigned a response period may not respond and may determine that it has nothing to signal. For example, the devices (e.g., device 1 305a, device 2 305b, device 3 305c, device 4 305d, and device 5 305e) may determine what response, if any, is required and may or may not respond to a request sent from the access point (e.g., access point 110 of FIG. 1). The response periods 320, 322, 324, 326, 328 may be assigned based on a request for such a period in an open transmission time, the request being sent to the access point (e.g., access point 110 of FIG. 1). The response periods 320, 322, 324, 326, 328 may be assigned based on which devices have been requested by the access point (e.g., access point 110 of FIG. 1) to send data or acknowledgements. The PA messages and responses may be frequency-hopped, time synchronized channels, and/or extended channels of the advertising channels in Bluetooth.

As previously mentioned, FIG. 4 shows an example PAwR for two groups of wireless network devices 420a, 420b (e.g., a first group including ESL1 to ESL 11, and a second group including ESL 12 to ESL 22). In particular, FIG. 4 is a signaling diagram illustrating an example of communication transmissions 400 between a network device 410 (e.g., a central device, which may be an access point) and two groups of wireless communication devices 420a, 420b (e.g., peripheral devices, which may be ESLs). With reference to FIG. 1, the signal sequence illustrated in FIG. 4 may be implemented by one or more of the communication connections, access points 110, and/or wireless communication devices 120 of FIG. 1.

In FIG. 4, the signaling diagram is shown in the form of a graph with an x-axis denoting time in milliseconds (ms) and a y-axis denoting specific wireless communication devices 420a, 420b (e.g., ESL1, ESL 2, ESL 3, ESL 4, ESL 5, ESL 6, ESL 7, ESL 8, ESL 9, ESL 10, ESL 11, ESL 12, ESL 13, ESL 14, ESL 15, ESL 16, ESL 17, ESL 18, ESL 19, ESL 20, ESL 21, and ESL 22). In particular, the x-axis of the graph of FIG. 4 denotes time starting from 0 ms and ending at 25 ms. The time can be divided into two subframes, which are each a length of 12.5 ms. As such, the two subframes may include a first subframe from 0 ms to 12.5 ms, and a second subframe from 12.5 ms to 25 ms. In one or more examples, there may be more or less than two subframes as is shown in FIG. 4, and/or each subframe may be longer or shorter than 12.5 ms as shown in FIG. 4.

In one or more examples, the wireless communication devices 420a, 420b (e.g., peripheral devices) may be assigned (e.g., by the network device 410 and/or by a network entity, such as a management entity) to different groups (e.g., two groups) of wireless communication devices 420a, 420b. For example, wireless communication devices 420a (e.g., ESL1, ESL 2, ESL 3, ESL 4, ESL 5, ESL 6, ESL 7, ESL 8, ESL 9, ESL 10, and ESL 11) may be assigned to a first group (e.g., group 1), and wireless communication devices 420b (e.g., ESL 12, ESL 13, ESL 14, ESL 15, ESL 16, ESL 17, ESL 18, ESL 19, ESL 20, ESL 21, and ESL 22) may be assigned to second group (e.g., group 2).

In FIG. 4, during operation for PAwR, at time 0 ms for the first subframe of time, the network device 410 (e.g., a central, such as an AP) may transmit 430a to a first group (e.g., group 1) of wireless communication devices 420a (e.g., ESL 1, ESL 2, ESL 3, ESL 4, ESL 5, ESL 6, ESL 7, ESL 8, ESL 9, ESL 10, and ESL 11) a PA containing a synchronization message (e.g., an AP synchronization message) over a synchronized channel between the network device 410 and the wireless communication devices 420a, 420b. As noted previously, a synchronization message can include one or more commands. For instance, a command can include an operational code (OpCode) and parameters associated with the command. At time 0 ms, the first group of wireless communication devices 420a (e.g., ESL 1, ESL 2, ESL 3, ESL 4, ESL 5, ESL 6, ESL 7, ESL 8, ESL 9, ESL 10, and ESL 11) can receive 435a the PA containing the synchronization message over the synchronized channel.

In one or more examples, the network device 410 may be configured to transmit PAs at a specified time interval (e.g., a subframe of time), such as at every 12.5 ms as is shown in FIG. 4. In one or more examples, the specified time interval (e.g., a subframe) may be shorter or longer than the 12.5 ms as is shown in FIG. 4. The wireless communication devices 420a, 420b may respond to a PA by using their specific respective response slot in time.

In one or more examples, the synchronization message transmitted 430a to the first group (e.g., group 1) of wireless communication devices 420a (e.g., ESL 1, ESL 2, ESL 3, ESL 4, ESL 5, ESL 6, ESL 7, ESL 8, ESL 9, ESL 10, and ESL 11) may indicate a respective response slot for one or more of the wireless communication devices 420a (e.g., ESL 1, ESL 2, ESL 3, ESL 4, ESL 5, ESL 6, ESL 7, ESL 8, ESL 9, ESL 10, and/or ESL 11) in the first group to use to transmit 440a a response to the network device 410. If a wireless communication device 420a (e.g., ESL 1, ESL 2, ESL 3, ESL 4, ESL 5, ESL 6, ESL 7, ESL 8, ESL 9, ESL 10, and ESL 11) is addressed within the synchronization message, the wireless communication device 420a (e.g., ESL 1, ESL 2, ESL 3, ESL 4, ESL 5, ESL 6, ESL 7, ESL 8, ESL 9, ESL 10, and ESL 11) can respond (e.g., transmit 440a) in its respective response slot, as indicated within the synchronization message.

For example, the synchronization message may indicate a specific sequence for one or more of the wireless communication devices 420a (e.g., ESL 1, ESL 2, ESL 3, ESL 4, ESL 5, ESL 6, ESL 7, ESL 8, ESL 9, ESL 10, and/or ESL 11) to respond (e.g., transmit 440a) in time (e.g., responding after 5 ms has elapsed after the start of the subframe at response slots located every 0.625 ms). For example, the sequence may indicate that wireless communication device 420a (e.g., ESL 1) should respond in a response slot located at 5 ms, wireless communication device 420a (e.g., ESL 2) should respond in a response slot located at 5.625 ms, wireless communication device 420a (e.g., ESL 3) should respond in a response slot located at 6.25 ms, wireless communication device 420a (e.g., ESL 4) should respond in a response slot located at 6.875 ms, wireless communication device 420a (e.g., ESL 5) should respond in a response slot located at 7.5 ms, wireless communication device 420a (e.g., ESL 6) should respond in a response slot located at 8.125 ms, wireless communication device 420a (e.g., ESL 7) should respond in a response slot located at 8.75 ms, wireless communication device 420a (e.g., ESL 8) should respond in a response slot located at 9.375 ms, wireless communication device 420a (e.g., ESL 9) should respond in a response slot located at 10 ms, wireless communication device 420a (e.g., ESL 10) should respond in a response slot located at 10.625 ms, and wireless communication device 420a (e.g., ESL 11) should respond in a response slot located at 11.25 ms.

After the wireless communication devices 420a (e.g., ESL 1, ESL 2, ESL 3, ESL 4, ESL 5, ESL 6, ESL 7, ESL 8, ESL 9, ESL 10, and ESL 11) have received 435a the PA containing the synchronization message from the network device 410, according to the sequence specified within the synchronization message, the one or more wireless communication devices 420a (e.g., ESL 1, ESL 2, ESL 3, ESL 4, ESL 5, ESL 6, ESL 7, ESL 8, ESL 9, ESL 10, and/or ESL 11) can transmit 440a their responses within their respective response slots. After the one or more wireless communication devices 420a (e.g., ESL 1, ESL 2, ESL 3, ESL 4, ESL 5, ESL 6, ESL 7, ESL 8, ESL 9, ESL 10, and/or ESL 11) have transmitted 440a their responses in their respective time slots, the network device 410 can receive 445a their transmitted responses at those specific response slot times.

Then, during operation for PAwR, at time 12.5 ms for the second subframe of time, the network device 410 may transmit 430b to a second group (e.g., group 2) of wireless communication devices 420b (e.g., ESL 12, ESL 13, ESL 14, ESL 15, ESL 16, ESL 17, ESL 18, ESL 19, ESL 20, ESL 21, and ESL 22) a PA containing a synchronization message over a synchronized channel between the network device 410 and the wireless communication devices 420a, 420b. In addition, at time 12.5 ms, the second group of wireless communication devices 420b (e.g., ESL 12, ESL 13, ESL 14, ESL 15, ESL 16, ESL 17, ESL 18, ESL 19, ESL 20, ESL 21, and ESL 22) can receive 435b the PA containing the synchronization message over the synchronized channel.

The synchronization message transmitted 430b to the second group (e.g., group 2) of wireless communication devices 420b (e.g., ESL 12, ESL 13, ESL 14, ESL 15, ESL 16, ESL 17, ESL 18, ESL 19, ESL 20, ESL 21, and ESL 22) may indicate a respective response slot for one or more of the wireless communication devices 420b (e.g., ESL 12, ESL 13, ESL 14, ESL 15, ESL 16, ESL 17, ESL 18, ESL 19, ESL 20, ESL 21, and/or ESL 22) in the second group to use to transmit 440b a response to the network device 410. If a wireless communication device 420b (e.g., ESL 12, ESL 13, ESL 14, ESL 15, ESL 16, ESL 17, ESL 18, ESL 19, ESL 20, ESL 21, and ESL 22) is addressed within the synchronization message, the wireless communication device 420b (e.g., ESL 12, ESL 13, ESL 14, ESL 15, ESL 16, ESL 17, ESL 18, ESL 19, ESL 20, ESL 21, and ESL 22) can respond (e.g., transmit 440b) in its respective response slot, as indicated within the synchronization message.

For example, the synchronization message may indicate a specific sequence for one or more of the wireless communication devices 420b (e.g., ESL 12, ESL 13, ESL 14, ESL 15, ESL 16, ESL 17, ESL 18, ESL 19, ESL 20, ESL 21, and/or ESL 22) to respond (e.g., transmit 440b) in time (e.g., responding after 5 ms has elapsed after the start of the subframe at response slots located every 0.625 ms). For example, the sequence may indicate that wireless communication device 420b (e.g., ESL 12) should respond in a response slot located at 17.5 ms, wireless communication device 420b (e.g., ESL 13) should respond in a response slot located at 18.125 ms, wireless communication device 420b (e.g., ESL 14) should respond in a response slot located at 18.75 ms, wireless communication device 420b (e.g., ESL 15) should respond in a response slot located at 19.375 ms, wireless communication device 420b (e.g., ESL 16) should respond in a response slot located at 20 ms, wireless communication device 420b (e.g., ESL 17) should respond in a response slot located at 20.625 ms, wireless communication device 420b (e.g., ESL 18) should respond in a response slot located at 21.25 ms, wireless communication device 420b (e.g., ESL 19) should respond in a response slot located at 21.875 ms, wireless communication device 420b (e.g., ESL 20) should respond in a response slot located at 22.5 ms, wireless communication device 420b (e.g., ESL 21) should respond in a response slot located at 23.125 ms, and wireless communication device 420b (e.g., ESL 22) should respond in a response slot located at 23.75 ms.

After the wireless communication devices 420b (e.g., ESL 12, ESL 13, ESL 14, ESL 15, ESL 16, ESL 17, ESL 18, ESL 19, ESL 20, ESL 21, and ESL 22) have received 435b the PA containing the synchronization message from the network device 410, according to the sequence specified within the synchronization message, the one or more wireless communication devices 420b (e.g., ESL 12, ESL 13, ESL 14, ESL 15, ESL 16, ESL 17, ESL 18, ESL 19, ESL 20, ESL 21, and/or ESL 22) may transmit 440b their responses within their respective response slots. After the one or more wireless communication devices 420b (e.g., ESL 12, ESL 13, ESL 14, ESL 15, ESL 16, ESL 17, ESL 18, ESL 19, ESL 20, ESL 21, and/or ESL 22) have transmitted 440b their responses in their respective time slots, the network device 410 can receive 445b their transmitted responses at those specific response slot times. Then, the PAwR may continue similarly for subsequent subframes of time.

As previously noted, ESLs (e.g., or other peripheral devices) may wake up from a dormant or sleeping state to perform an onboarding process with an AP (e.g., or other central device of an ESL system). ESLs can be added to an ESL system based on onboarding performed between an AP of the ESL system and each respective ESL. In some cases, an ME is associated with one or more APs and can control the onboarding of ESLs performed by the APs.

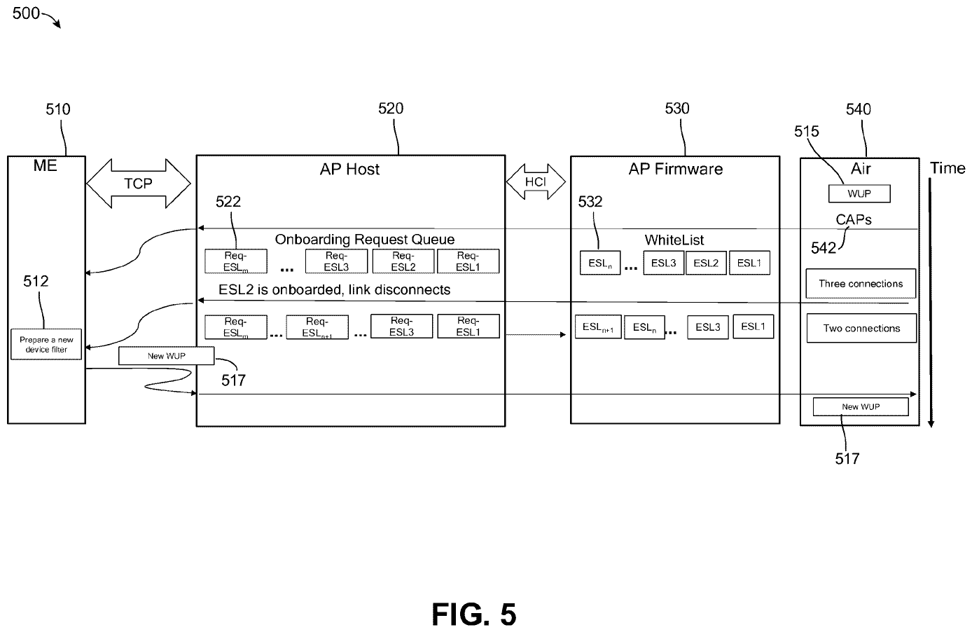

For example, FIG. 5 is a diagram 500 illustrating an example of onboarding performed using a management entity (ME) and an access point (AP) of a synchronization system (e.g., an ESL system). An ME 510 can be associated with one or more APs, where the ME 510 and the one or more APs are included in an ESL system. In the example of FIG. 5, a single AP is depicted. Each AP can be associated with an AP host 520 and an AP firmware (FW) 530. In some cases, the ME 510 can be the same as or similar to the ME 130 of FIG. 1. In some examples, the AP (e.g., AP host 520 and AP FW 530) can be the same as or similar to the AP 110 of FIG. 1.

ME 510 can communicate with AP host 520, for example using one or more Transmission Control Protocol (TCP) communication links. The AP host 520 can communicate with the AP FW 530 via a Host Controller Interface (HCl). For instance, the AP host 520 can use the HCl to access a baseband controller and/or baseband capabilities of the AP FW 530. The AP FW 530 can implement one or more wireless communication links over a wireless communication media 540 (e.g., shown in FIG. 5 as the “air”). Although not shown in the example diagram 500 of FIG. 5, one or more ESLs can wirelessly communicate over the air 540 with the AP FW 530.

As mentioned previously, in existing approaches to onboarding of ESLs in an ESL system, an ESL that has not yet been onboarded, or is otherwise awaiting onboarding, can enter a dormant or sleep state while awaiting an onboarding indication or other onboarding trigger. For example, ESLs that have not been onboarded with an ESL system (e.g., have not been onboarded with AP host 520 and/or ME 510) can remain in a dormant or sleep state until a wake-up packet (WUP) is received. For example, a timer can be used to periodically cause an ESL to wake from the dormant state and check to see if a WUP is received. The ESL may return to the dormant state if a WUP is not received within a pre-determined duration following the periodic wakeup.

A WUP can indicate to one or more ESLs (e.g., one or more ESLs receiving the WUP) that the ESL is within communication range of an active ESL system and that the ESL should attempt to perform an onboarding process with the ESL system. As noted previously, WUP formation can be controlled by a management entity (e.g., such as ME 510) and WUP transmission can be performed by an AP associated with the management entity (e.g., such as AP 520). For instance, a WUP 515 can be generated by ME 510, transmitted to AP host 520, and put on the air 540 by AP FW 530.

A plurality of ESLs can receive the WUP 515. A device filter field value of WUP 515 can be used to determine if WUP 515 is valid or invalid for a respective ESL of the plurality of ESLs. For example, WUP 515 can be addressed to a subset of ESLs included in the plurality of ESLs, based on a respective device address value associated with each ESL of the subset being greater than the device filter value associated with WUP 515. The respective device address value associated with each ESL of the subset can be determined based on a device identifier of each ESL, such as the Bluetooth Device Address (BD_ADDR) of each ESL. In one illustrative example, the respective device address value associated with each ESL can be determined as the sum of the octets of the BD_ADDR corresponding to the ESL.

If WUP 515 is valid for a respective ESL (e.g., is addressed to a respective ESL, based on the device filter value of WUP 515 and the BD_ADDR octet sum of the respective ESL), receiving WUP 515 can cause the respective ESL to wake up and attempt to perform onboarding with the AP 520. If WUP 515 is not valid for a respective ESL, the respective ESL will return to a sleeping or dormant mode and wait for a future WUP transmission. For example, a timer can be used to periodically cause an ESL to wake from the dormant state and check to see if the ESL receives a valid WUP. The ESL may return to the dormant state if a valid WUP is not received within a pre-determined duration following the periodic wakeup. An ESL may not perform an onboarding process with AP 520 until receiving a WUP having a device filter field value indicating that the particular WUP is valid for the ESL.

In some cases, ME 510 can generate WUPs (e.g., such as WUP 515) to include a device filter field value that is indicative of a range of ESLs (e.g., a subset of the plurality of ESLs) for which the WUP is valid. For instance, ME 510 can generate WUP 515 to include a device filter field value that indicates a range of ESL addresses or identifiers for which WUP 515 is valid. Each respective ESL of a plurality of ESLs that receive WUP 515 can use the device filter field value to determine whether the received WUP 515 is valid for the respective ESL. For instance, the device filter field can have a value that is chosen (e.g., by ME 510) such that the sum of the octets of the BD_ADDR of a first subset of ESLs is less than the device filter field value and the sum of the octets of the BD_ADDR of a second subset of ESLs is greater than or equal to the device filter field value. In one illustrative example, WUP 515 can be considered valid by an ESL if the device filter field value of WUP 515 is less than or equal to the sum of the octets of the BD_ADDR of the ESL (e.g., in the example above, WUP 515 would be valid for the second subset of ESLs).

ESLs for which WUP 515 is valid (e.g., ESLs having a BD_ADDR with an octet sum greater than the device filter field value of WUP 515) can each transmit a Connectable Advertising Packet (CAP) 542. Each CAP 542 can include information indicative of an identity of the ESL, and may be used by AP 520 and/or ME 510 to onboard the ESL identified by or otherwise corresponding to the particular CAP.

The CAPs 542 transmitted by the ESLs for which WUP 515 is valid can be received over the air 540 using AP FW 530. For instance, the CAPs 542 may be received during a scan interval or scan time implemented per subframe (e.g., every 12.5 ms) by AP FW 530. Based on receiving the CAPs 542, the AP FW 530 can identify a particular ESL corresponding to each of the CAPs 542 as ready for onboarding. For example, AP FW 530 can be associated with a whitelist of one or more whitelisted ESLs 532 (e.g., ESLn, . . . , ESL3, ESL2, ESL1) for onboarding. In some aspects, the AP FW 530 can update and/or maintain the whitelist of ESLs for onboarding based on receiving information from ME 510 indicative of the particular ESLs that have been identified or selected for onboarding. For example, the ME 510 can determine the ESL whitelist information provided to AP FW 530 based on or corresponding to the ESLs for which the device filter field of WUP 515 will be considered valid.

Based on receiving the CAPs 542, the AP FW 530 can determine whether the particular ESL identified by each CAP 542 is present in the AP FW whitelist. If a CAP 542 is received for a whitelisted ESL 532, a link between the AP and the whitelisted ESL 532 can be established, based on the available link capacity of the AP. For example, APs and/or other network entities in an ESL system may have a limited quantity of communication links that can be used to perform onboarding (e.g., establish synchronization) with ESLs. In some cases, an AP may support a maximum of three simultaneous or concurrent links with ESLs. In many examples, an ESL system may be associated with a plurality of peripheral devices (e.g., ESLs) that are to be onboarded at the same time. For instance, when an ESL system is initially installed and configured at a given location (e.g., such as a supermarket or other retail environment), thousands of ESLs may need to be onboarded at approximately the same time. In some cases, the onboarding of a plurality of ESLs may also be referred to as “massive onboarding.”

When an onboarding request from an ESL arrives at the AP FW 530, the ESL address associated with the onboarding request can be added into the whitelist of ESLs if there are available entries/slots (e.g., regardless the link capacity). If AP FW 530 has available link capacity, a link can be established with the whitelisted ESL 532 and onboarding can be performed. If AP FW 530 determines that there is no available link capacity (e.g., the “three connections” state depicted in air 540), a link will not be established between the AP FW 530 and the whitelisted ESL 532. As illustrated, the onboarding request queue at AP host 520 can include one or more queued ESL onboarding requests 522 that are each indicative of a whitelisted ESL 532 that is awaiting an available link at the AP for onboarding (e.g., Req-ESLm, . . . , Req-ESL3, Req-ESL2, Req-ESL1).

As ESLs are onboarded, AP host 520 can update the whitelist of ESLs and the onboarding request queue to remove the corresponding onboarding requests for each ESL that has been successfully onboarded. AP host 520 may additionally communicate with ME 510, for example providing information indicative of onboarding results at the AP.

ME 510 can receive and analyze onboarding information from the AP host 520 to determine whether the WUP device filter field should be changed. For example, decreasing the WUP device filter field value will awaken additional ESLs for onboarding and maintaining the WUP device filter field value will prevent additional ESLs from awakening for onboarding.

In one illustrative example, ME 510 can determine whether to update the WUP device filter field based on information indicative of successful or unsuccessful onboarding completion for some (or all) of the ESLs in the AP host 520 ESL onboarding request queue and/or some (or all) of the ESLs in the AP FW 530 whitelist; information indicative of a CAP density corresponding to the CAPs 542 received by AP FW 530; and/or information indicative of the link states of AP FW 530; etc.

When ME 510 determines, based on the available information at ME 510, that the WUP device filter field value should be updated, the ME 510 can generate a new device filter 512 with an updated device filter field value. ME 510 can subsequently generate and transmit, to AP host 520, a new (e.g., updated) WUP 517 that includes the updated device filter field value 512. The new WUP 517 can be transmitted from AP host 520 to AP firmware 530, which puts the new WUP 517 on the air 540 for receipt by the plurality of ESLs, and the process described above may repeat until the plurality of ESLs have been successfully onboarded to the ESL system.

The onboarding information available to ME 510 is often inaccurate and/or incomplete, which can cause ME 510 to inefficiently update the device filter field 512. For instance, ME 510 can use CAP density information indicative of the quantity of CAPs received at the AP within a pre-determined time period (e.g., subframe, etc.). However, the ME 510 is unaware of the actual time spent scanning by AP FW 530 during the pre-determined time period, and may be unable to utilize accurate CAP density or CAP receive rate information when updating the WUP device filter field. For instance, AP FW 530 may spend 30% of a subframe as scan time (e.g., during which the CAPs 542 are received), but ME 510 knows only that the CAPs 542 were received over 100% of the subframe time, and may underestimate the CAP density by greater than a factor of 3.

Additionally, ME 510 experiences some communication latency or lag in determining (e.g., becoming aware of) connection state changes at the AP. For example, after AP host 520 completes onboarding of the ESL corresponding to the queued onboarding request Req-ESLm 522, a link becomes available and the AP FW 530 transitions from a “three connections” state to a “two connections” state (e.g., as shown in the air 540 of FIG. 5). ME 510 does not became aware of the available link capacity at the AP until the available link information has propagated or otherwise been communicated to ME 510 by the AP host 520. An additional latency or lag in controlling the massive onboarding process for the plurality of ESLs may be introduced by the propagation delay in the updated WUP 517, as after being generated by ME 510 with the updated device filter field 512, the updated WUP 517 must be transmitted between ME 510 to AP host 520 and from AP host 520 to AP FW 530 before then going on the air 540 to the plurality of ESLs.

In one illustrative example, the systems and techniques described herein can perform improved onboarding of a plurality of ESLs based on generating and transmitting updated WUPs (e.g., using updated device filter field values) using one or more APs of an ESL system. As will be described in greater depth below, an updated WUP with an updated device filter field value can be generated and transmitted by an AP based on receive rate information (e.g., CAP rate information) determined by the AP and corresponding to one or more CAPs received by the AP. In some aspects, the updated device filter field value can additionally be determined based on link state information of the AP (e.g., available links for onboarding). The link state information of the AP is determined by the AP.

In some aspects, an AP of an ESL system can be authorized (e.g., by an ME of the ESL system) to automatically update the device filter field of an initialized WUP received from the ME. The authorization can be based on the initialized WUP including a device filter authorization field indicating that an AP (e.g., an AP receiving the initialized WUP from the ME) is authorized to determine updated device filter values and implement subsequent WUP formation using the updated device filter field value(s). In some cases, the updated WUPs generated and transmitted by the AP can utilize device filter field values that more accurately correspond to a current status of the onboarding of a plurality of ESLs with the AP. For instance, the AP can generate updated device filter field values using CAP rate information that is determined based on the quantity of CAPs received during a scan time associated with the AP (e.g., which can be more accurate than an ME-determined CAP rate information that may not reflect the AP scan time during a given time period, such as a subframe).

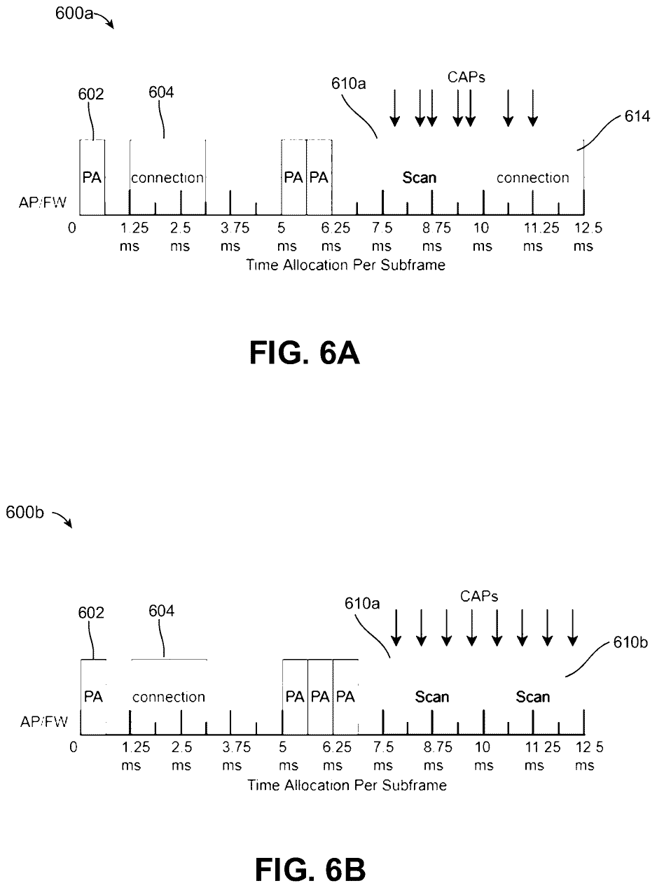

For instance, FIGS. 6A and 6B are diagrams illustrating examples of different CAP receive rates corresponding to different total scan times implemented over a time period such as a subframe. For example, FIG. 6A depicts an example subframe time allocation 600a for a 12.5 ms subframe. In the example subframe time allocation 600a, slots are allocated for a first PA 602, a first connection period 604, second and third PAs 602, a single scan period 610a, and a second connection period 614. As noted previously, CAPs may be transmitted by ESLs at various times during an AP subframe time allocation (e.g., such as the subframe time allocation 600a), with the AP successfully receiving only those CAPs that arrive during an allocated scan time of the subframe. For instance, FIG. 6A depicts a total of seven CAPs, five of which arrive during the scan period 610a and two of which arrive during the second connection period 614. In this example, the five CAPs arriving during scan period 610a are successfully received while the two CAPs arriving after the scan period 610a (e.g., arriving during the second connection period 614) are not received by the AP.

In one illustrative example, a CAP receive rate (e.g., also referred to as a “CAP rate”) can be determined as

$$CAP rate = \frac{{N}_{CAP}}{{T}_{scan}} ,$$

where N_{CAP} represents the total quantity of CAPs received during a scan time of the time period (e.g., subframe) and T_{scan} represents the total scan time during the same time period (e.g., subframe). In the example of FIG. 6A, the CAP rate is equal to 5 CAP/3.125 ms=1.6 CAP/ms. However, when an ME is unaware of the total scan time per subframe (or other pre-determined time period), as described above with respect to ME 510, an inaccurate CAP rate may be determined based on dividing the quantity of received CAPs by the total time period (e.g., 5 CAP/12.5 ms=0.4 CAP/ms).

In another example, FIG. 6B depicts an example subframe time allocation 600b for a 12.5 ms subframe. In the example subframe time allocation 600b, slots are allocated for a first PA 602, a first connection period 604, second through fourth PAs 602, a first scan period 610a, and a second scan period 610b. Here, a total of eight CAPs are shown, each of which arrives during either the first scan period 610a or the second scan period 610b, and can be successfully received by an AP. The corresponding CAP rate can be determined as 8 CAP/5 ms=1.6 CAP/ms. In an example where an ME is unaware of the total scan time per subframe, an inaccurate CAP rate may be determined based on dividing the quantity of received CAPs by the total time period (e.g., 8 CAP/12.5 ms=0.64 CAP/ms).

In some aspects, a current CAP rate associated with an AP can be determined based on information indicative of the time allocation per subframe for different tasks (e.g., connection, scan, PAs, etc.). For example, an AP can use its time allocation per subframe information to determine the corresponding T_{scan} for calculating a CAP rate in any respective subframe of a plurality of subframes associated with the AP. In one illustrative example, the current CAP rate and/or the T_{scan} for a particular subframe associated with an AP can be determined by an AP firmware (FW), such as the AP FW 530 of FIG. 5. In some aspects, an AP can use the corresponding time allocation information of the AP to determine a CAP rate per frame. For instance, an AP can determine N_{CAP} as the total quantity of CAPs received during a frame and can determine as the sum of the respective scan time for each subframe of a plurality of subframes included in the frame.

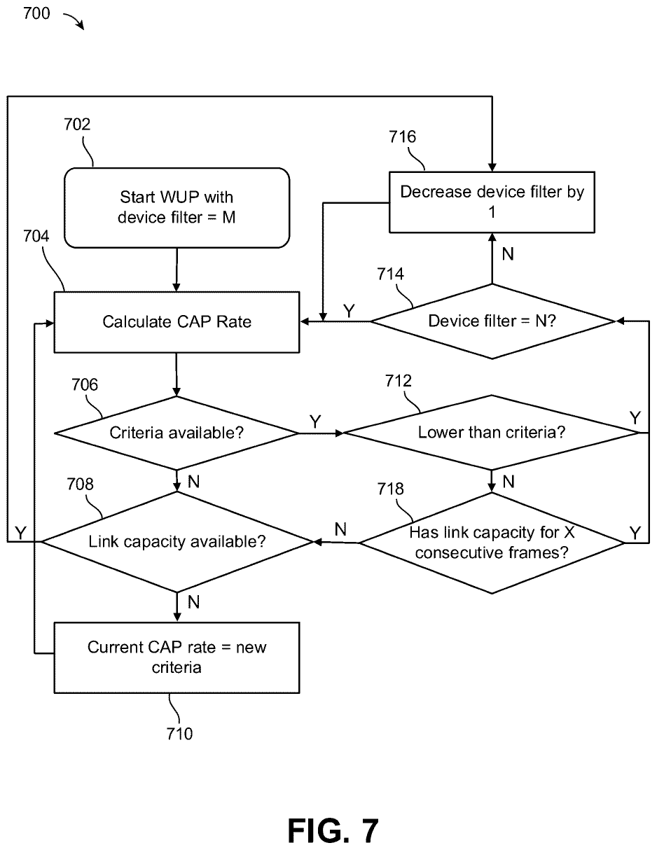

FIG. 7 is a flow diagram illustrating an example of an onboarding process 700 that can be performed based on a WUP device filter field that is updated by an AP of an ESL system, in accordance with some examples. In one illustrative example, the onboarding process 700 can be performed by an AP that is the same as or similar to one or more of the APs 110 of FIG. 1, the AP 410 of FIG. 4, the AP host 520 of FIG. 5 and/or the AP FW 530 of FIG. 5, etc.

At operation 702, a WUP can be started with a device filter field value of M. For example, the AP can transmit (e.g., broadcast) a WUP with device filter=M, indicating that any ESLs receiving the WUP and having a BD_ADDR with an octet sum greater than or equal to M should wake up and transmit a CAP for onboarding with an AP. In some aspects, the WUP of operation 702 can be an initial WUP that is generated by an ME associated with the AP. For instance, the AP can receive the initial WUP from an ME included in the same ESL system as the AP. In some examples, the ME can determine a range of device identifiers and/or device addresses corresponding to a plurality of ESLs to be onboarded, and may generate a corresponding device filter value range based on the device identifiers. For example, the ME can determine the range of BD_ADDRs associated with a plurality of ESLs to be onboarded and, based on determining an octet sum for each of the BD_ADDRs, can generate a corresponding range of device filter values [N, M].

The device filter value N can be referred to as a first address of the device filter range. A WUP with a device filter value=N will be valid for each ESL of the plurality of ESLs (e.g., the octet sum of the BD_ADDR of each ESL will be greater than or equal to N). The device filter value M can be referred to as a last address of the device filter range. A WUP with a device filter value=M will only be valid for one or more ESL of the plurality of ESLs (e.g., the one or more ESLs having the BD_ADDR octet sum that is equal to M; the remaining ESLs have a BD_ADDR octet sum <M, indicating that the WUP with device filter=M is invalid for the remaining ESLs). For instance, in some cases, multiple ESLs may map to M or N due to the calculation of the device filter (e.g., an octet sum for each of the BD_ADDR).

In some aspects, the AP can receive an initial WUP from the ME. The initial WUP includes an initial device filter field value of M. Starting WUP formation with the device filter=M can be used to implement a gradual wakeup and ESL onboarding process, as transmitting the initial WUP with device filter=M causes the one or more ESLs mapped to M to awake and transmit a respective CAP onboarding request.

As noted previously, the initial WUP received by the AP from the ME can additionally include a device filter authorization field indicative of an authorization from the ME to offload WUP formation to the AP. In one illustrative example, the device filter authorization field can authorize an AP (e.g., AP host, such as the AP host 520 of FIG. 5) receiving the initial WUP from the ME to offload WUP formation to an AP firmware (e.g., such as the AP FW 530 of FIG. 5), as will be described in greater depth below.

At operation 704, the AP can determine a receive rate for one or more time periods. In one illustrative example, the AP can determine a CAP receive rate (e.g., “CAP rate”) associated with the current frame or subframe of the AP. In another example, the AP can determine a CAP rate associated with the most recent full frame or subframe of the AP. The CAP rate of operation 704 can be determined based on

$$CAP rate == \frac{{N}_{CAP}}{{T}_{scan}} ,$$

as described previously above. In some cases, such as when proceeding from operation 702 to operation 704, the determined CAP rate can correspond to the initial WUP transmitted (e.g., broadcast) to the plurality of ESLs by the AP in operation 702. For example, the determined CAP rate can correspond to the initial WUP with device filter=M that is transmitted (e.g., broadcast) by the AP at operation 702. In other examples, the determined CAP rate of operation 704 can correspond to a most recent WUP and device filter field value, both of which may be updated by the AP to be different from the initial WUP and initial device filter field value provided by the ME.

At operation 706, the AP can determine whether a criteria is available for evaluating the CAP rate determined at operation 704. In one illustrative example, the criteria may initially be unavailable, and the massive onboarding process 700 can proceed to operation 708.

At operation 708, the AP can determine whether link capacity is available at the AP. For example, the AP can determine whether the AP FW has available link capacity, where each available link of the available link capacity can be used to initiate onboarding with one ESL. In one illustrative example, the AP may be associated with a total or maximum link capacity of three links. In this example, the AP may determine at operation 708 that there is an available link capacity of two. Of the three total links associated with the AP, one link is used to onboard the ESL corresponding to the last address of the ESL device range [N, M] (e.g., the ESL having the greatest BD_ADDR octet sum, which is equal to the initial WUP device filter M used at operation 702). The two remaining links are unused for onboarding and represent the available link capacity of two.

In one illustrative example, if link capacity is determined to be available at operation 708, the AP (e.g., the AP FW) can decrease or decrement the WUP device filter value at operation 716 by one until an available AP link capacity of zero is determined (e.g., link capacity is determined not to be available at operation 708). For instance, the CAP receive rate of the AP may be relatively small as the massive onboarding process 700 is beginning, and decrementing the WUP device filter value can be used to gradually increase the quantity of ESLs being simultaneously onboarded until the available links at the AP become fully saturated (e.g., all available links at the AP being used for onboarding of ESLs). In some aspects, each decrement of the WUP device filter field can wake one or more additional ESLs to transmit a CAP. As noted previously, the initial WUP with device filter=M is valid for only one or more ESLs having the last address of the ESL range [N, M] (e.g., a WUP is valid for an ESL when the device filter value≤sum of the octets of the ESL BD_ADDR). An updated WUP with device filter=M−1 is valid for two or more ESLs [M−1, M]; an updated WUP with device filter=M−2 is valid for three or more ESLs [M−2, M]; etc.

Based on decrementing the device filter value (and transmitting an updated WUP using each respective decremented device filter value), the AP can gradually wake ESLs one by one until all available links of the AP are saturated with ESL onboarding requests (e.g., each ESL onboarding request corresponding to a CAP transmitted by an ESL in response to receive a WUP with a valid device filter relative to the ESLs BD_ADDR).

The current or most recent CAP rate (e.g., determined at operation 704) when the AP determines that the maximum quantity of links associated with the AP are being utilized (e.g., corresponding to a determination of no link capacity available at operation 708) can be used as the new criteria. For example, at operation 710, the current or most recent CAP rate determined at operation 704 can be used as the new criteria corresponding to operation 706.

After updating the criteria at operation 710, the massive onboarding process 700 can return to operation 704 and determine the current CAP rate, as described above. In some cases, the current CAP rate can be determined as the CAP rate for the most recent full frame (e.g., most recent 1.6 seconds). In some examples, the current CAP rate can be determined as the CAP rate for the most recent full subframe (e.g., most recent 12.5 ms). In other examples, the current CAP rate can be determined as the CAP rate for a pre-determined time period, including but not limited to a pre-determined quantity of frames, subframes, or portions thereof. In some aspects, the current CAP rate determined at operation 704 can be the CAP rate over the time period since the last CAP rate determination previously made at operation 704. In some examples, the CAP rate determination of operation 704 can be accumulative, such that the T_{scan} (e.g., of the calculation

$$CAP rate == \frac{{N}_{CAP}}{{T}_{scan}} )$$

increases for each instance in which the CAP rate calculation of operation 704 is performed. In still other examples, the CAP rate determination of operation 704 can be accumulative for a limited or sliding window of time (such as the most recent 5 frames, the most recent 10 frames, the most recent 10 subframes, the most recent 25 subframes, etc.). At the end of a limited window of time, the CAP rate calculation can be reset. At the end of a sliding window of time, the oldest received CAPs and corresponding scan times can be discarded and replaced with the most recently received CAPs and corresponding scan times.

In some aspects, initializing the massive onboarding process 700 to start WUP formation with a device filter field value=M can be used to slowly increase the quantity of ESLs being onboarded, from one or more ESLs mapped to M (e.g., with the BD_ADDR octet sum equal to M) to a greater quantity of ESLs such that the maximum link capacity of the onboarding AP becomes saturated (e.g., fully utilized). As mentioned above, the WUP device filter can be decremented until no available links are associated with the AP. The CAP rate associated with saturating or fully utilizing the AP links can be set as the new criteria against which further adjustments to the device filter can be evaluated.

For instance, in one illustrative example, the AP can continue the massive onboarding process 700 based on monitoring the current CAP rate (e.g., periodically updating the current CAP rate determination using operation 704) until the current CAP rate is determined to be less than the criteria set in operation 710.

For example, after setting the current CAP rate as the new criteria at operation 710, an updated CAP rate can be determined at operation 704 (e.g., as described previously above). Subsequently, at operation 706, the AP can determine that a criteria is available, based on the criteria previously set at operation 710 as described above.

At operation 712, the AP can compare the current CAP rate determined at operation 704 to the criteria previously updated at operation 710. If the CAP rate drops lower than the criteria (e.g., if the current CAP rate is less than the criteria value), the AP can decrease the WUP device filter value to wake additional ESLs for onboarding. For example, based on determining that the current CAP rate is less than the criteria (e.g., at operation 712), the AP can decrement the device filter value by one at operation 716. The updated device filter value (e.g., the previous device filter value decremented by one) can be used by the AP to generate and transmit a corresponding updated WUP with the updated device filter value to trigger additional ESLs to wake and transmit a CAP.

In some aspects, an operation 714 can be performed prior to decrementing the device filter value at operation 716. For example, operation 714 can determine whether the device filter value can be decremented further, based on comparing the current device filter value to N (e.g., the first device filter address of the range [N, M] determined by the ME). In some examples, the AP can obtain or otherwise determine the first address of the device filter range, N, based on information received from the ME. In one illustrative example, from operation 714, the process 700 may proceed to operation 716 and decrement the device filter value by one if the current device filter >N and may return to operation 704 if the current device filter=N. After decrementing the device filter value by one, the process 700 may also return to operation 704.

Returning to the discussion of operation 712, in which the current CAP rate is compared to the criteria value, the process 700 may proceed to operation 718 based on a determination that the current CAP rate is not lower than the criteria value. For instance, if the current CAP rate is greater than or equal to the criteria value, at operation 718 the AP can determine and/or update a counter corresponding to a quantity of consecutive frames (or subframes and/or other time periods) in which the AP has had available link capacity. For example, the AP can determine whether the AP has had available link capacity for X consecutive frames (or other time periods). For instance, the consecutive frames are consecutive frames that occurred prior to the current frame associated with the AP. In one illustrative example, the AP can determine whether the AP had available link capacity of at least one link for three consecutive frames (e.g., X=3).

Based on determining that the AP has available link capacity for a pre-determined quantity of consecutive frames (e.g., at least one available link for the prior X frames), the AP can decrease the WUP device filter value to wake additional ESLs for onboarding. For instance, based on determining, at operation 718, available link capacity for the pre-determined quantity of consecutive frames, the AP can decrease the device filter value and transmit an updated WUP as described above with respect to operation 716.

The AP can continue to decrease the device filter value and transmit corresponding updated WUPs to wake additional ESLs for onboarding until the maximum quantity of links supported by the AP are determined to be occupied (e.g., unavailable). For example, when the AP's maximum supported links are utilized, the AP can determine at operation 718 that link capacity has not been available for the pre-determined quantity of consecutive frames and can further determine at operation 708 that no link capacity is currently available. Based on no available link capacity at operation 708, the AP can set the current CAP rate as the new criteria at operation 710, and may return to operation 704.

In some aspects, the massive onboarding process 700 can be terminated based on determining that all ESLs associated with the device filter range [N, M] have been onboarded (e.g., based on determining that no additional ESLs of the device filter range [N, M] remain for onboarding). For example, the ME associated with the AP may terminate the massive onboarding process 700 performed by the AP.

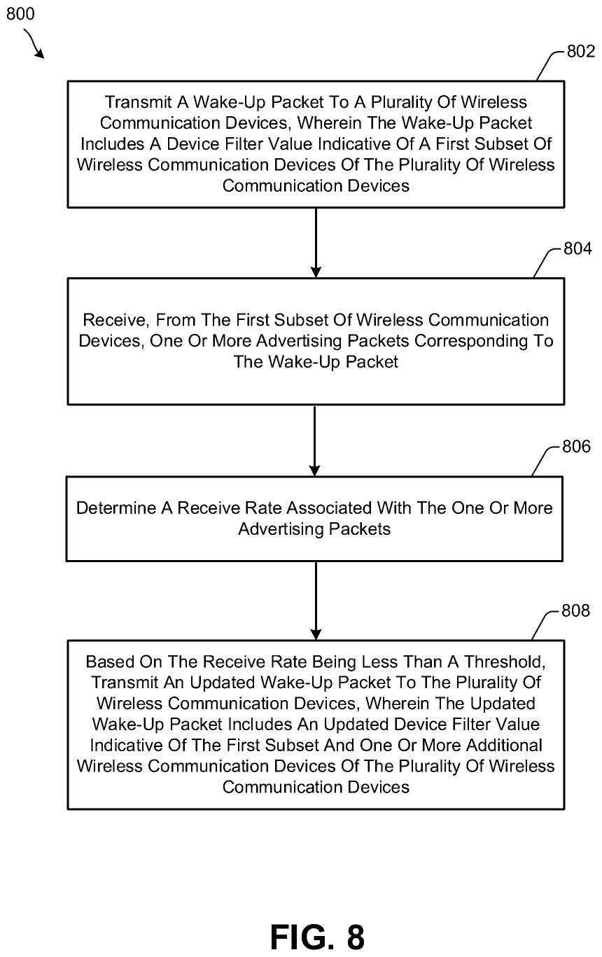

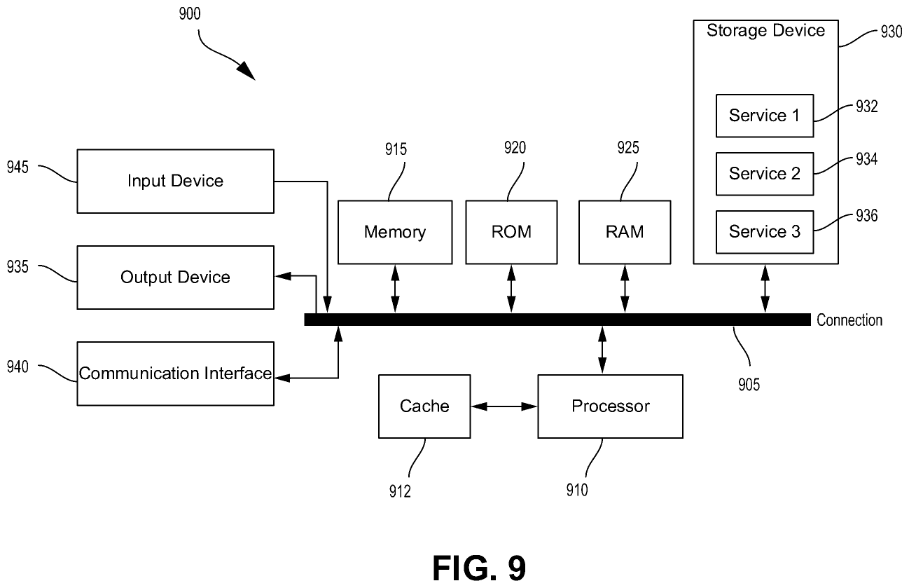

FIG. 8 is a flow chart illustrating an example of a process 800 for wireless communications. The process 800 can be performed by a network entity (e.g., such as the access point 110, the management entity 130, a PAwR central device, etc.) or by a component or system (e.g., a chipset) thereof. The operations of the process 800 may be implemented as software components that are executed and run on one or more processors (e.g., processor 910 of FIG. 9 or other processor(s)). Further, the transmission and reception of signals by the network entity in the process 800 may be enabled, for example, by one or more antennas and/or one or more transceivers (e.g., wireless transceiver(s)).

At block 802, the network entity (or component thereof) can transmit a wake-up packet (e.g., wake-up packet (WUP) 515 of FIG. 5) to a plurality of wireless communication devices (e.g., a plurality of electronic shelf label (ESL) devices). The wake-up packet includes a device filter value indicative of a first subset of wireless communication devices of the plurality of wireless communication devices. In some cases, the device filter value is included in a device filter field of the wake-up packet (e.g., device filter field of WUP 515 of FIG. 5). In some aspects, each wireless communication device of the plurality of wireless communication devices is associated with a respective device address value. In such aspects, the wake-up packet addresses a wireless communication device of the plurality of wireless communication devices based on the respective device address value being greater than the device filter value. In some cases, the network entity (or component thereof) can determine the respective device address value as a sum of one or more octets included in a respective device identifier associated with each wireless communication device of the plurality of wireless communication devices. In one illustrative example, the respective device identifier comprises a Bluetooth Device Address (BD_ADDR).

In some aspects, to transmit the wake-up packet, the network entity (or component thereof) can receive the wake-up packet from a second network entity and transmit the wake-up packet to the plurality of wireless communication devices. In one illustrative example, the network entity an AP (e.g., AP 110 of FIG. 1, AP FW 530 of FIG. 5, or other AP) and the second network entity is a ME associated with the AP (e.g., ME 130 of FIG. 1, ME 510 of FIG. 5, or other ME). In some cases, the wake-up packet includes a device filter authorization field indicative of authorization to offload updated wake-up packet formation from the second network entity to the network entity. In some examples, to transmit the updated wake-up packet, the network entity (or component thereof) can determine the updated device filter value based on the wake-up packet including the device filter authorization field. In such examples, the network entity (or component thereof) can generate the updated wake-up packet using the wake-up packet and the updated device filter value (updated based on the wake-up packet including the device filter authorization field).

At block 804, the network entity (or component thereof) can receive, from the first subset of wireless communication devices, one or more advertising packets corresponding to the wake-up packet. In some aspects, each advertising packet of the one or more advertising packets is a Connectable Advertising Packet (CAP) (e.g., CAPs 542 of FIG. 5) associated with an onboarding request for a respective wireless communication device of the first subset of wireless communication devices.

At block 806, the network entity (or component thereof) can determine a receive rate associated with the one or more advertising packets. In some cases, the network entity (or component thereof) can receive the one or more advertising packets during a time period. In such cases, the network entity (or component thereof) can determine the receive rate as a quantity of the one or more advertising packets divided by the time period. In some examples, the network entity (or component thereof) can determine the time period as a total scan time of the network entity during a frame or can determine the time period as a total scan time of the network entity during a subframe of a plurality of subframes included in the frame.

At block 808, the network entity (or component thereof) can transmit, based on the receive rate being less than a threshold, an updated wake-up packet to the plurality of wireless communication devices. The updated wake-up packet includes an updated device filter value indicative of the first subset and one or more additional wireless communication devices of the plurality of wireless communication devices. In some cases, each wireless communication device of the first subset is associated with a respective device address value that is greater than the device filter value (as noted above) and the updated device filter value, and each wireless communication device of the one or more additional wireless communication devices is associated with a respective device address value that is less than the device filter value and greater than the updated device filter value.

In some aspects, the network entity (or component thereof) can determine the threshold based on one or more of the receive rate, an available link capacity of the network entity, a maximum link capacity of the network entity, any combination thereof, and/or other information. For instance, in some cases, the network entity (or component thereof) can transmit one or more updated wake-up packets using successively decremented respective updated device filter values until a corresponding receive rate associated with a particular updated wake-up packet is equal to the maximum link capacity. In such cases, network entity (or component thereof) can use the corresponding receive rate associated with the particular updated wake-up packet as the threshold. In some cases, the network entity (or component thereof) can determine the updated device filter value by decrementing the device filter value (e.g., by performing operation 716 of the process 700 of FIG. 7).

In some cases, the network entity (or component thereof) can determine, based on the receive rate being greater than or equal to the threshold, a quantity of consecutive previous time periods each associated with a respective available link capacity that is less than the maximum link capacity (e.g., by performing operation 712 of the process 700 of FIG. 7). Based on the quantity being greater than or equal to a pre-determined quantity, the network entity (or component thereof) can transmit a second updated wake-up packet using the updated device filter value decremented by one. In some examples, the network entity (or component thereof) can determine a corresponding receive rate associated with the second updated wake-up packet. In such examples, based on the corresponding receive rate being equal to the maximum link capacity, network entity (or component thereof) can update the threshold by setting the threshold equal to the corresponding receive rate.

The network entity, network device, and/or the wireless communication device may include various components, such as one or more input devices, one or more output devices, one or more processors, one or more microprocessors, one or more microcomputers, one or more cameras, one or more sensors, one or more receivers, transmitters, and/or transceivers, and/or other component(s) that are configured to carry out the steps of processes described herein. In some examples, the computing device may include a display, a network interface configured to communicate and/or receive the data, any combination thereof, and/or other component(s). The network interface may be configured to communicate and/or receive Internet Protocol (IP) based data or other type of data.

The components of a device configured to perform the process 800 of FIG. 8 can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

The process 800 is illustrated as a logical flow diagram, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 800 and/or other processes described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 9 is a block diagram illustrating an example of a computing system 900, which may be employed by the disclosed systems and techniques. In particular, FIG. 9 illustrates an example of computing system 900, which can be, for example, any computing device making up internal computing system, a remote computing system, a camera, or any component thereof in which the components of the system are in communication with each other using connection 905. Connection 905 can be a physical connection using a bus, or a direct connection into processor 910, such as in a chipset architecture. Connection 905 can also be a virtual connection, networked connection, or logical connection.

In some aspects, computing system 900 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 900 includes at least one processing unit (CPU or processor) 910 and connection 905 that communicatively couples various system components including system memory 915, such as read-only memory (ROM) 920 and random-access memory (RAM) 925 to processor 910. Computing system 900 can include a cache 912 of high-speed memory connected directly with, in close proximity to, or integrated as part of processor 910.

Processor 910 can include any general-purpose processor and a hardware service or software service, such as services 932, 934, and 936 stored in storage device 930, configured to control processor 910 as well as a special-purpose processor where software instructions are incorporated into the actual processor design. Processor 910 may essentially be a completely self-contained computing system, containing multiple cores or processors, a bus, memory controller, cache, etc. A multi-core processor may be symmetric or asymmetric.

To enable user interaction, computing system 900 includes an input device 945, which can represent any number of input mechanisms, such as a microphone for speech, a touch-sensitive screen for gesture or graphical input, keyboard, mouse, motion input, speech, etc. Computing system 900 can also include output device 935, which can be one or more of a number of output mechanisms. In some instances, multimodal systems can enable a user to provide multiple types of input/output to communicate with computing system 900.

Computing system 900 can include communications interface 940, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 940 may also include one or more range sensors (e.g., LIDAR sensors, laser range finders, RF radars, ultrasonic sensors, and infrared (IR) sensors) configured to collect data and provide measurements to processor 910, whereby processor 910 can be configured to perform determinations and calculations needed to obtain various measurements for the one or more range sensors. In some examples, the measurements can include time of flight, wavelengths, azimuth angle, elevation angle, range, linear velocity and/or angular velocity, or any combination thereof. The communications interface 940 may also include one or more Global Navigation Satellite System (GNSS) receivers or transceivers that are used to determine a location of the computing system 900 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 930 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 930 can include software services, servers, services, etc., that when the code that defines such software is executed by the processor 910, it causes the system to perform a function. In some aspects, a hardware service that performs a particular function can include the software component stored in a computer-readable medium in connection with the necessary hardware components, such as processor 910, connection 905, output device 935, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories can include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random-access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein can be replaced with less than or equal to (“≤”) and greater than or equal to (“>”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Illustrative aspects of the disclosure include:

Aspect 1. A network entity for wireless communications, the network entity comprising: at least one memory; and at least one processor coupled to the at least one memory and configured to: transmit a wake-up packet to a plurality of wireless communication devices, wherein the wake-up packet includes a device filter value indicative of a first subset of wireless communication devices of the plurality of wireless communication devices; receive, from the first subset of wireless communication devices, one or more advertising packets corresponding to the wake-up packet; determine a receive rate associated with the one or more advertising packets; and based on the receive rate being less than a threshold, transmit an updated wake-up packet to the plurality of wireless communication devices, wherein the updated wake-up packet includes an updated device filter value indicative of the first subset and one or more additional wireless communication devices of the plurality of wireless communication devices.

Aspect 2. The network entity of Aspect 1, wherein the at least one processor is configured to: determine the threshold based on at least one of the receive rate, an available link capacity of the network entity, or a maximum link capacity of the network entity.

Aspect 3. The network entity of Aspect 2, wherein the at least one processor is configured to: transmit one or more updated wake-up packets using successively decremented respective updated device filter values until a corresponding receive rate associated with a particular updated wake-up packet is equal to the maximum link capacity; and use the corresponding receive rate associated with the particular updated wake-up packet as the threshold.

Aspect 4. The network entity of any one of Aspects 2 or 3, wherein the at least one processor is configured to determine the updated device filter value by decrementing the device filter value.

Aspect 5. The network entity of any one of Aspects 2 to 4, wherein the at least one processor is configured to: based on the receive rate being greater than or equal to the threshold, determine a quantity of consecutive previous time periods each associated with a respective available link capacity that is less than the maximum link capacity; and based on the quantity being greater than or equal to a pre-determined quantity, transmit a second updated wake-up packet using the updated device filter value decremented by one.

Aspect 6. The network entity of Aspect 5, wherein the at least one processor is configured to: determine a corresponding receive rate associated with the second updated wake-up packet; and based on the corresponding receive rate being equal to the maximum link capacity, update the threshold by setting the threshold equal to the corresponding receive rate.

Aspect 7. The network entity of any one of Aspects 1 to 6, wherein, to transmit the wake-up packet, the at least one processor is configured to: receive the wake-up packet from a second network entity; and transmit the wake-up packet to the plurality of wireless communication devices.

Aspect 8. The network entity of Aspect 7, wherein: the network entity is an access point (AP); and the second network entity is a management entity (ME) associated with the AP.

Aspect 9. The network entity of any one of Aspects 7 or 8, wherein: the wake-up packet includes a device filter authorization field indicative of authorization to offload updated wake-up packet formation from the second network entity to the network entity.

Aspect 10. The network entity of Aspect 9, wherein, to transmit the updated wake-up packet, the at least one processor is configured to: determine the updated device filter value based on the wake-up packet including the device filter authorization field; and generate the updated wake-up packet using the wake-up packet and the updated device filter value, based on the wake-up packet including the device filter authorization field.

Aspect 11. The network entity of any one of Aspects 1 to 10, wherein: each wireless communication device of the plurality of wireless communication devices is associated with a respective device address value; and the wake-up packet addresses a wireless communication device of the plurality of wireless communication devices based on the respective device address value being greater than the device filter value.

Aspect 12. The network entity of Aspect 11, wherein the at least one processor is configured to: determine the respective device address value as a sum of one or more octets included in a respective device identifier associated with each wireless communication device of the plurality of wireless communication devices.

Aspect 13. The network entity of Aspect 12, wherein the respective device identifier comprises a Bluetooth Device Address (BD_ADDR).

Aspect 14. The network entity of any one of Aspects 1 to 13, wherein: each wireless communication device of the first subset is associated with a respective device address value that is greater than the device filter value and the updated device filter value; and each wireless communication device of the one or more additional wireless communication devices is associated with a respective device address value that is less than the device filter value and greater than the updated device filter value.

Aspect 15. The network entity of any one of Aspects 1 to 14, wherein the device filter value is included in a device filter field of the wake-up packet.

Aspect 16. The network entity of any one of Aspects 1 to 15, wherein each wireless communication device of the plurality of wireless communication devices is an electronic shelf label (ESL) device.

Aspect 17. The network entity of any one of Aspects 1 to 16, wherein each advertising packet of the one or more advertising packets is a Connectable Advertising Packet (CAP) associated with an onboarding request for a respective wireless communication device of the first subset of wireless communication devices.

Aspect 18. The network entity of any one of Aspects 1 to 17, wherein the at least one processor is configured to: receive the one or more advertising packets during a time period; and determine the receive rate as a quantity of the one or more advertising packets divided by the time period.

Aspect 19. The network entity of Aspect 18, wherein the at least one processor is configured to: determine the time period as a total scan time of the network entity during a frame; or determine the time period as a total scan time of the network entity during a subframe of a plurality of subframes included in the frame.

Aspect 20. A method for wireless communications performed by a network entity, the method comprising: transmitting a wake-up packet to a plurality of wireless communication devices, wherein the wake-up packet includes a device filter value indicative of a first subset of wireless communication devices of the plurality of wireless communication devices; receiving, from the first subset of wireless communication devices, one or more advertising packets corresponding to the wake-up packet; determining a receive rate associated with the one or more advertising packets; and based on the receive rate being less than a threshold, transmitting an updated wake-up packet to the plurality of wireless communication devices, wherein the updated wake-up packet includes an updated device filter value indicative of the first subset and one or more additional wireless communication devices of the plurality of wireless communication devices.

Aspect 21. The method of Aspect 20, further comprising: determining the threshold based on at least one of the receive rate, an available link capacity of the network entity, or a maximum link capacity of the network entity.

Aspect 22. The method of Aspect 21, further comprising: transmitting one or more updated wake-up packets using successively decremented respective updated device filter values until a corresponding receive rate associated with a particular updated wake-up packet is equal to the maximum link capacity; and using the corresponding receive rate associated with the particular updated wake-up packet as the threshold.

Aspect 23. The method of any one of Aspects 21 or 22, further comprising determining the updated device filter value by decrementing the device filter value.

Aspect 24. The method of any one of Aspects 21 to 23, further comprising: based on the receive rate being greater than or equal to the threshold, determining a quantity of consecutive previous time periods each associated with a respective available link capacity that is less than the maximum link capacity; and based on the quantity being greater than or equal to a pre-determined quantity, transmitting a second updated wake-up packet using the updated device filter value decremented by one.

Aspect 25. The method of Aspect 24, further comprising: determining a corresponding receive rate associated with the second updated wake-up packet; and based on the corresponding receive rate being equal to the maximum link capacity, updating the threshold by setting the threshold equal to the corresponding receive rate.

Aspect 26. The method of any one of Aspects 21 to 25, wherein transmitting the wake-up packet comprises: receiving the wake-up packet from a second network entity; and transmitting the wake-up packet to the plurality of wireless communication devices.

Aspect 27. The method of Aspect 26, wherein: the network entity is an access point (AP); and the second network entity is a management entity (ME) associated with the AP.

Aspect 28. The method of any one of Aspects 26 or 27, wherein: the wake-up packet includes a device filter authorization field indicative of authorization to offload updated wake-up packet formation from the second network entity to the network entity.

Aspect 29. The method of Aspect 28, wherein transmitting the updated wake-up packet comprises: determining the updated device filter value based on the wake-up packet including the device filter authorization field; and generating the updated wake-up packet using the wake-up packet and the updated device filter value, based on the wake-up packet including the device filter authorization field.

Aspect 30. The method of any one of Aspects 20 to 29, wherein: each wireless communication device of the plurality of wireless communication devices is associated with a respective device address value; and the wake-up packet addresses a wireless communication device of the plurality of wireless communication devices based on the respective device address value being greater than the device filter value.

Aspect 31. The method entity of Aspect 30, further comprising: determining the respective device address value as a sum of one or more octets included in a respective device identifier associated with each wireless communication device of the plurality of wireless communication devices.

Aspect 32. The method of Aspect 31, wherein the respective device identifier comprises a Bluetooth Device Address (BD_ADDR).

Aspect 33. The method of any one of Aspects 20 to 32, wherein: each wireless communication device of the first subset is associated with a respective device address value that is greater than the device filter value and the updated device filter value; and each wireless communication device of the one or more additional wireless communication devices is associated with a respective device address value that is less than the device filter value and greater than the updated device filter value.

Aspect 34. The method of any one of Aspects 20 to 33, wherein the device filter value is included in a device filter field of the wake-up packet.

Aspect 35. The method of any one of Aspects 20 to 34, wherein each wireless communication device of the plurality of wireless communication devices is an electronic shelf label (ESL) device.

Aspect 36. The method of any one of Aspects 20 to 35, wherein each advertising packet of the one or more advertising packets is a Connectable Advertising Packet (CAP) associated with an onboarding request for a respective wireless communication device of the first subset of wireless communication devices.

Aspect 37. The method of any one of Aspects 20 to 36, further comprising: receiving the one or more advertising packets during a time period; and determining the receive rate as a quantity of the one or more advertising packets divided by the time period.

Aspect 38. The method of Aspect 37, further comprising: determining the time period as a total scan time of the network entity during a frame; or determining the time period as a total scan time of the network entity during a subframe of a plurality of subframes included in the frame.

Aspect 39. A non-transitory computer-readable medium having stored thereon instructions that, when executed by at least one processor, cause the at least one processor to perform operations according to any of Aspects to 20 to 38.

Aspect 40. An apparatus for wireless communications, comprising one or more means for performing operations according to any of Aspects 20 to 38.

1. A network entity for wireless communications, the network entity comprising:
at least one memory; and
at least one processor coupled to the at least one memory and configured to:
transmit a wake-up packet to a plurality of wireless communication devices, wherein the wake-up packet includes a device filter value indicative of a first subset of wireless communication devices of the plurality of wireless communication devices;
receive, from the first subset of wireless communication devices, one or more advertising packets corresponding to the wake-up packet;
determine a receive rate associated with the one or more advertising packets; and
based on the receive rate being less than a threshold, transmit an updated wake-up packet to the plurality of wireless communication devices, wherein the updated wake-up packet includes an updated device filter value indicative of the first subset and one or more additional wireless communication devices of the plurality of wireless communication devices.

2. The network entity of claim 1, wherein the at least one processor is configured to:
determine the threshold based on at least one of the receive rate, an available link capacity of the network entity, or a maximum link capacity of the network entity.

3. The network entity of claim 2, wherein the at least one processor is configured to:
transmit one or more updated wake-up packets using successively decremented respective updated device filter values until a corresponding receive rate associated with a particular updated wake-up packet is equal to the maximum link capacity; and
use the corresponding receive rate associated with the particular updated wake-up packet as the threshold.

4. The network entity of claim 2, wherein the at least one processor is configured to determine the updated device filter value by decrementing the device filter value.

5. The network entity of claim 2, wherein the at least one processor is configured to:
based on the receive rate being greater than or equal to the threshold, determine a quantity of consecutive previous time periods each associated with a respective available link capacity that is less than the maximum link capacity; and
based on the quantity being greater than or equal to a pre-determined quantity, transmit a second updated wake-up packet using the updated device filter value decremented by one.

6. The network entity of claim 5, wherein the at least one processor is configured to:
determine a corresponding receive rate associated with the second updated wake-up packet; and
based on the corresponding receive rate being equal to the maximum link capacity, update the threshold by setting the threshold equal to the corresponding receive rate.

7. The network entity of claim 1, wherein, to transmit the wake-up packet, the at least one processor is configured to:
receive the wake-up packet from a second network entity; and
transmit the wake-up packet to the plurality of wireless communication devices.

8. The network entity of claim 7, wherein:
the network entity is an access point (AP); and
the second network entity is a management entity (ME) associated with the AP.

9. The network entity of claim 7, wherein:
the wake-up packet includes a device filter authorization field indicative of authorization to offload updated wake-up packet formation from the second network entity to the network entity.

10. The network entity of claim 9, wherein, to transmit the updated wake-up packet, the at least one processor is configured to:
determine the updated device filter value based on the wake-up packet including the device filter authorization field; and
generate the updated wake-up packet using the wake-up packet and the updated device filter value, based on the wake-up packet including the device filter authorization field.

11. The network entity of claim 1, wherein:
each wireless communication device of the plurality of wireless communication devices is associated with a respective device address value; and
the wake-up packet addresses a wireless communication device of the plurality of wireless communication devices based on the respective device address value being greater than the device filter value.

12. The network entity of claim 11, wherein the at least one processor is configured to:
determine the respective device address value as a sum of one or more octets included in a respective device identifier associated with each wireless communication device of the plurality of wireless communication devices.

13. The network entity of claim 12, wherein the respective device identifier comprises a Bluetooth Device Address (BD_ADDR).

14. The network entity of claim 1, wherein:
each wireless communication device of the first subset is associated with a respective device address value that is greater than the device filter value and the updated device filter value; and
each wireless communication device of the one or more additional wireless communication devices is associated with a respective device address value that is less than the device filter value and greater than the updated device filter value.

15. The network entity of claim 1, wherein the device filter value is included in a device filter field of the wake-up packet.

16. The network entity of claim 1, wherein each wireless communication device of the plurality of wireless communication devices is an electronic shelf label (ESL) device.

17. The network entity of claim 1, wherein each advertising packet of the one or more advertising packets is a Connectable Advertising Packet (CAP) associated with an onboarding request for a respective wireless communication device of the first subset of wireless communication devices.

18. The network entity of claim 1, wherein the at least one processor is configured to:
receive the one or more advertising packets during a time period; and
determine the receive rate as a quantity of the one or more advertising packets divided by the time period.

19. The network entity of claim 18, wherein the at least one processor is configured to:
determine the time period as a total scan time of the network entity during a frame; or
determine the time period as a total scan time of the network entity during a subframe of a plurality of subframes included in the frame.

20. A method for wireless communications performed by a network entity, the method comprising:
transmitting a wake-up packet to a plurality of wireless communication devices, wherein the wake-up packet includes a device filter value indicative of a first subset of wireless communication devices of the plurality of wireless communication devices;
receiving, from the first subset of wireless communication devices, one or more advertising packets corresponding to the wake-up packet;
determining a receive rate associated with the one or more advertising packets; and
based on the receive rate being less than a threshold, transmitting an updated wake-up packet to the plurality of wireless communication devices, wherein the updated wake-up packet includes an updated device filter value indicative of the first subset and one or more additional wireless communication devices of the plurality of wireless communication devices.

21-30. (canceled)
